(19) United States
(12) Patent Application Publication
(10) Pub. No.: US 2007/0150828 A1
(43) Pub. Date: Jun. 28, 2007

(54) CONTENT SEARCH METHOD

(76) Inventors: Yujin Tsukada, Saitama (JP); Takeshi Hoshino, Kodaira (JP); Takayuki Yamamoto, Fujisawa (JP); Kouji Urawaki, Fujisawa (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/616,063

(22) Filed: Dec. 26, 2006

(30) Foreign Application Priority Data
Dec. 27, 2005 (JP) JP 2005-375633

(51) Int. Cl. G06F 17/30

(52) U.S. Cl. 715/777; 707/5

(57) ABSTRACT

A content search screen has a rectangular content list display area. A display area for the attribute “genre” is arranged above the content list display area, and a display area for the attribute “device (storage location)” is arranged at the left of the content list display area. The attribute “genre” display area displays genre selection buttons for selecting genres such as movie and drama. The attribute “device” display area displays device selection buttons for selecting devices such as server or personal computer (PC). Pieces of content in a content list displayed in the content list display area satisfy a search criterion corresponding to the selected genre selection button in the attribute “genre” display area and a search criterion corresponding to the selected device selection button in the attribute “device” display area.

### CLAIM OF PRIORITY

The present application claims priority from Japanese application JP 2005-375633 filed on Dec. 27, 2005, the content of which is hereby incorporated by reference into this application.

### BACKGROUND OF THE INVENTION

1. Field of the Invention

The present invention relates to content search methods for searching various pieces of saved content, such as recorded programs or the like.

2. Description of the Related Art

When pieces of content, such as television (TV) programs, are accumulated and saved in a household apparatus such as a recorder, a desired piece of content is played using a content search method for obtaining the desired piece of content from among many pieces of saved content. One such known method involves displaying a content search screen on a display screen and allowing a user to operate the content search screen to select the desired piece of content.

In a home network system in which electronic devices (clients) such as a household TV receiver and a personal computer (PC) are integrated with one another, a technique is proposed, for example, in Japanese Unexamined Patent Application Publication No. 2004-220404, for allowing a client to request and obtain a recorded program stored in a home server constituting the system.

In the technique described in Japanese Unexamined Patent Application Publication No. 2004-220404, a piece of content (recorded program) is registered in a hard disk drive (HDD) of the home server, and an internal table serving as content management information is stored in a database. In the internal table, a main key indicating the title of the content and subkeys indicating various attributes of the content are registered. If the content is music data, the attributes indicated by the subkeys include “artist”, “album”, “genre”, or the like. Each piece of content has an attribute value for each of the attributes (subkeys) (for example, the attribute “album” has “best album 1”).

In response to a request for content from the client to the home server, a content search screen based on information in the internal table is displayed. The content search screen displays a list of all subkeys relating to the attributes of pieces of content defined by the internal table and the titles of the pieces of content serving as main keys. By selecting one subkey (attribute) from the list, attribute values (e.g., artist names) registered in the internal table under the selected subkey are displayed. By selecting one attribute value from among the attribute values, titles corresponding to the selected attribute value (titles of pieces of content of the artist) are selected from among the displayed titles and are displayed. In this case, one of the other displayed subkeys can be selected. By doing so, content having the attribute value indicated by the selected subkey is further selected from among the already selected content titles and is displayed.

In the technique described in Japanese Unexamined Patent Application Publication No. 2004-220404, attributes and their attribute values have a hierarchical structure. By selecting one of subkeys indicating all attributes displayed on the content search screen, attribute values at a hierarchy level below the selected subkey are displayed. The user can never know attribute values at a lower hierarchical level unless the user selects the subkey corresponding to each attribute and changes the screen to display the attribute values at a hierarchy level below the selected attribute.

Once the attribute value is selected, the attribute under which the attribute value has been selected is indicated only by the subkey displayed at a predetermined position indicating the fact that the attribute value has been selected. The user can neither recognize which attribute value under the attribute has been selected nor check which attribute value has been selected to show the displayed titles. It thus takes more time for the user to change the attribute value to be selected.

### SUMMARY OF THE INVENTION

In order to solve the above problems, it is an object of the present invention to provide a content search method for allowing a user to set all necessary search criteria without switching a screen and to check the set search criteria at anytime.

To achieve the aforementioned object, there is provided a content search method for searching saved content through operation of a displayed content search screen. The method includes arranging a content list display area in which a content list is displayed on the content search screen; arranging, along at least two sides of the content list display area, search criteria display areas for displaying search criteria selection buttons indicating different search criteria for searching for content; and setting the search criteria by selecting the search criteria selection buttons and displaying, in the content list display area, the content list based on the set search criteria as a list of a plurality of pieces of attribute information of pieces of content, the pieces of attribute information being arranged horizontally.

From among pieces of content that match the set search criteria, a desired piece of content is preferably obtained by selecting the desired piece of content from the content list displayed in the content list display area.

In the search criteria display areas, the selected search criteria selection buttons may be displayed on tabs protruding from the content list display area, and the unselected search criteria selection buttons may be displayed independently and separately from one another.

Each of the search criteria display areas preferably has a one/all selection button, and, by operating the one/all selection button, the search criteria display area may be switched between a state in which all the search criteria selection buttons are selected and a state in which one of the search criteria selection buttons is selected.

Each of the search criteria display areas preferably has a state selection button, and, by operating the state selection button, the search criteria display area may be switched between a state in which all the search criteria selection buttons are selected and a state in which an arbitrary number of the search criteria selection buttons are selected.

A plurality of sorting selection buttons are preferably provided, and, by selecting and operating one of the sorting selection buttons, the pieces of content in the content list are preferably sorted according to the selected sorting button.

A piece of content selected from the content list may be displayed with a thumbnail.

A processing menu is preferably displayed by selecting one of the pieces of content from the content list displayed in the content list display area. The processing menu may selectively allow the selected piece of content to be played, deleted, moved or copied to a recording medium of another device.

At least one of the search criteria preferably has a hierarchical structure, and a display area may be provided for search criteria of a higher hierarchical level and a display area is provided for search criteria of a lower hierarchical level. The display areas each have the search criteria selection buttons. By selecting an arbitrary one of the search criteria selection buttons in the display area for the search criteria of the higher hierarchical level, the selection buttons may be displayed in the display area for the search criteria of the lower hierarchical level corresponding to the search criterion indicated by the selected selection button.

At least two of the selection buttons may be selectable in the display area for the search criteria of the higher hierarchical level. By selecting the at least two selection buttons, the content list displayed in the content list display area may include pieces of content that satisfy at least one of the search criteria indicated by the selected selection buttons.

The content list displayed in the content list display area may be an electronic program guide obtained from a broadcasting program signal, and a recorded program matching the search criteria indicated by the selected search criteria selection buttons may be displayed in the electronic program guide.

The content list displayed in the content list display area may include thumbnails of the pieces of content, which are arranged and displayed in three dimensions.

The pieces of content in the content list displayed in the content list display area may include a recorded program, a program scheduled to be recorded, and a program that is neither recorded nor scheduled to be recorded.

Accordingly, all necessary search criteria can be set without switching the screen, and all the set search criteria can be checked at anytime. Therefore, errors in the search criteria can be corrected easily, thereby reliably avoiding errors. Operations involved in searching for content become simpler and user-friendlier.

### BRIEF DESCRIPTION OF THE DRAWINGS

FIG. 1 is a diagram showing the system configuration of a home network system using a content search method according to the present invention;

FIG. 2 is a schematic block diagram of main units of a TV receiver or a recorder shown in FIG. 1;

FIG. 3 is a schematic block diagram of main units of a PC shown in FIG. 1;

FIG. 4 is a flowchart showing the operation upon activation of a client shown in FIG. 1;

FIG. 5 is a table schematically showing a specific example of a content list created by the client;

FIG. 6 shows a first specific example of a content search screen;

FIG. 7 shows a second specific example of a content search screen;

FIG. 8 shows a third specific example of a content search screen;

FIG. 9 shows a fourth specific example of a content search screen;

FIG. 10 shows a fifth specific example of a content search screen;

FIG. 11 shows a sixth specific example of a content search screen;

FIGS. 12A and 12B show specific examples of a remote controller used to operate the content search screen;

FIG. 13 shows a specific example of a screen operating method for operating the content search screen shown in FIG. 8;

FIG. 14 shows a flow of change in the screen subsequent to a display state shown in FIG. 13(d);

FIG. 15 shows sorting of pieces of content in a content list on the content search screen shown in FIG. 7 by way of example;

FIG. 16 shows sorting of pieces of content in a content list on the content search screen shown in FIG. 8 by way of example;

FIG. 17 shows another specific example of a method of displaying content selected from the content list on the content search screen shown in FIG. 8 by way of example;

FIG. 18 shows another specific example of a content list displayed in a content list display area of the content search screen shown in FIG. 8 by way of example;

FIG. 19 shows a seventh specific example of a content search screen;

FIG. 20 shows an eighth specific example of a content search screen;

FIG. 21 shows a ninth specific example of a content search screen;

FIG. 22 shows a tenth specific example of a content search screen;

FIG. 23 is a table schematically showing another example of a content list created by the client;

FIG. 24 shows an eleventh specific example of a content search screen; and

FIGS. 25A and 25B show specific examples of a content search screen on which a search can be conducted through recorded programs and programs scheduled to be recorded.

### DESCRIPTION OF THE PREFERRED EMBODIMENTS

Embodiments of the present invention will be described with reference to the drawings.

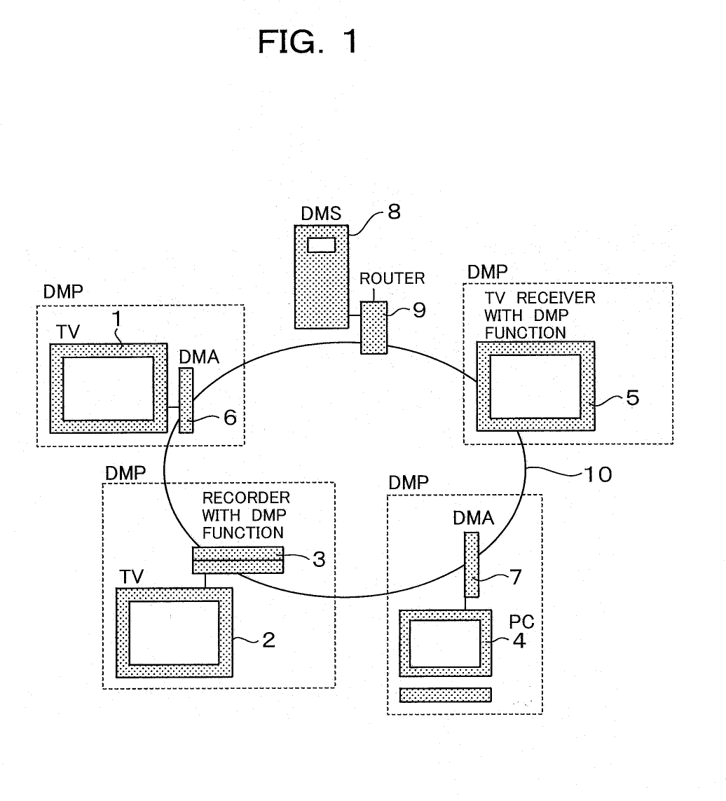

FIG. 1 shows the system configuration of a home network system using a content search method according to the present invention. Specifically, FIG. 1 shows TV receivers 1 and 2, a recorder with a digital media player (DMP) function 3, a PC 4, a TV receiver with a DMP function 5, digital media adapters (DMAs) 6 and 7, a digital media server (DMS) 8, a router 9, and a network 10.

Referring to FIG. 1, the home network system is a network system in which various household devices compliant with the Digital Living Network Alliance (DLNA), namely, DMPs, are connected to the single network 10 connected via the router 9 to the DMS 8, whereby the DMS 8 can communicate with the DMPs and the DMPs can communicate with one another. In the following description, the DMS 8 is simply referred to as the server 8.

The DLNA guidelines are designed to connect audio-visual (AV) devices and PCs with one another on a home network and to allow the devices to share information such as moving images, still images, sounds, or the like with one another. By connecting the DLNA-compliant household devices to the same network, a broadcast program currently being received can be received, viewed, and recorded by any of the household devices. Furthermore, any of the household devices can obtain and show a recorded program stored in another household device connected to the network.

The household devices other than the server 8 may collectively be referred to as a “client”.

Each of the DMPs shown in FIG. 1 is a DLNA-compliant device and serves as a client to connect to the network 10. The TV receiver with the DMP function 5 is a DLNA-compliant device and can directly connect to the network 10. In contrast, the TV receivers 1 and 2 and the PC 4 are not compliant with DLNA. Such a DLNA-non-compliant device can be treated as a DLNA-compliant device by using a DMA. Using the DMA 6, the TV receiver 1 is connected as a DMP to the network 10. Using the DMA 7, the PC 4 is connected as a DMP to the network 10. By connecting the recorder with the DMP function 3 to the TV receiver 2, the TV receiver 2 is connected as a DMP to the network 10 via the recorder with the DMP function 3.

In this home network system, any of the TV receivers 1 and 2, the PC 4, and the TV receiver with the DMP function 5 can obtain and show content, such as a broadcast program received by any of these devices or a recorded program stored in any of these devices. Furthermore, a recorded program can be transferred to the server 8 and stored in the server 8. Needless to say, any of the TV receivers 1 and 2, the PC 4, and the TV receiver with the DMP function 5 which are connected to the network 10 can obtain content, such as a recorded program, stored in the server 8.

Here, the client is described as the TV receiver 1 or 2, the PC 4, or the TV receiver with the DMP function 5 by way of example. However, the client is not limited to these devices.

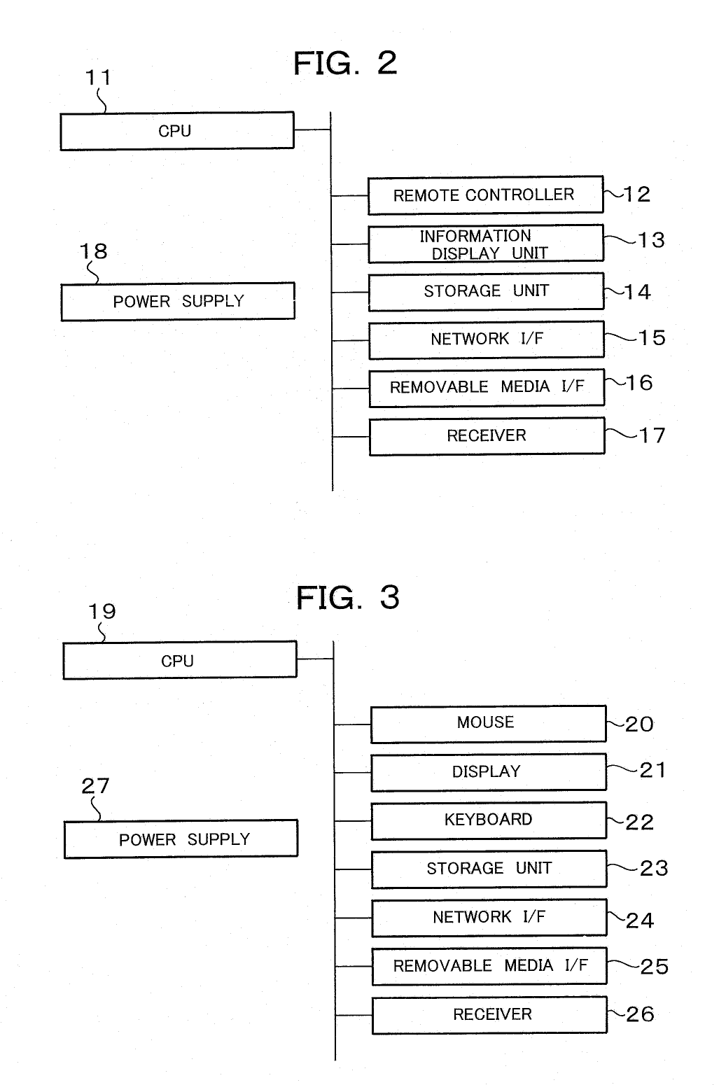

FIG. 2 is a schematic block diagram of main units of the TV receiver 1, 2, or 5 or the recorder 3 shown in FIG. 1. Specifically, FIG. 2 shows a central processing unit (CPU) 11, a remote controller 12, an information display unit 13, a storage unit 14, a network interface (I/F) 15, a removable media I/F 16, a receiver 17, and a power supply 18.

Referring to FIG. 2, when the power supply 18 is turned on, the CPU 11 controls the state and operation of each unit in accordance with operation of the remote controller 12. The network I/F 15 is connected to the network 10 (FIG. 1) and communicates with other devices via the network 10. A removable medium (recording medium) for use in a camcorder or the like is connectable to the removable media I/F 16. The removable media I/F 16 can read content, such as a moving image or a still image captured with the camcorder or a recorded radio program, from the connected removable medium or can record such content in the removable medium. The receiver 17 receives a broadcast program. By operating the remote controller 12, a broadcasting channel can be selected. By operating the remote controller 12, the received broadcast program or the content read by the removable media I/F 16 from the removable medium can be displayed on the information display unit 13 or can be stored in the storage unit 14 including a hard disk and a digital versatile disk (DVD). Screen operations such as moving a cursor on the information display unit 14 are performed using the remote controller 12.

Information about a screen for searching for content such as a program currently being broadcast or a recorded program (content search screen) is recorded in the storage unit 14. Such information is read and displayed on the information display unit 13 in accordance with operation of the remote controller 12.

The remote controller 12 has operation means, such as a cross cursor key, which will be described later, for operating the cursor on the content search screen displayed on the information display unit 13, which will be described later. Furthermore, the remote controller 12 has additional operation means for operating portions of the content search screen other than those that can be operated using the cursor.

In addition, a list of attribute information of content recorded in the storage unit 14 (hereinafter referred to as a “content list”) is created and recorded in the storage unit 14. When a broadcast program received by the receiver 17 is recorded in the storage unit 14 or when content read by the removable media I/F 16 from the removable medium is recorded in the storage unit 14, attribute information of that content is added to the content list. When content recorded in the storage unit 14 is deleted, attribute information of the deleted content is also deleted from the content list.

In response to a request for the content list from another client including the PC 4 (which is received by the network I/F 15), the content list is read from the storage unit 14, output from the network I/F 15 to the network 10 (FIG. 1), and transmitted to the client having issued the request. The content list transmitted from the server 8 or another client is received by the network I/F 15 and stored in the storage unit 14.

FIG. 3 is a schematic block diagram of main units of the PC 4 shown in FIG. 1. Specifically, FIG. 3 shows a CPU 19, a mouse 20, a display 21, a keyboard 22, a storage unit 22, a network I/F 24, a removable media I/F 25, a receiver 26, and a power supply 25.

Referring to FIG. 3, when the power supply 27 is turned on, the CPU 19 controls the state and operation of each unit in accordance with operation of the mouse 20 for controlling a mouse pointer, which will be described later, or the keyboard 22 having operation means for operating the cursor, which will be described later. The network I/F 24 is connected to the network 10 (FIG. 1) and communicates with other devices via the network 10. A removable medium (recording medium) for use in a camcorder or the like is connectable to the removable media I/F 25. The removable media I/F 25 can read content, such as a moving image or a still image captured with the camcorder or a recorded radio program, from the connected removable medium or can record such content in the removable medium. The receiver 26 receives a broadcast program. By operating the mouse 20 or the keyboard 22, a broadcasting channel can be selected. By operating the mouse 20 or the keyboard 22, the received broadcast program or the content read by the removable media I/F 25 from the removable medium can be displayed on the display 21 or can be recorded in the storage unit 23 including a hard disk and a DVD. Screen operations such as moving a cursor on the display 21 are performed using the mouse 20 or the keyboard 22.

Information about a screen for searching for content such as a program currently being broadcast or a recorded program (content search screen) is recorded in the storage unit 23. Such information is read and displayed on the display 21 in accordance with operation of the mouse 20 or the keyboard 22.

In addition, a list of attribute information of content recorded in the storage unit 23 (hereinafter referred to as a “content list”) is created and recorded in the storage unit 23. When a broadcast program received by the receiver 26 is recorded in the storage unit 23 or when content read by the removable media I/F 25 from the removable medium is recorded in the storage unit 23, attribute information of that content is added to the content list. When content recorded in the storage unit 23 is deleted, attribute information of the deleted content is also deleted from the content list. In response to a request for the content list from another client (which is received by the network I/F 24), the content list is read from the storage unit 23, output from the network I/F 24 to the network 10 (FIG. 1), and transmitted to the client having issued the request. The content list transmitted from another client is received by the network I/F 24 and stored in the storage unit 23.

In response to a request for content from another client (which is received by the network I/F 24), the requested content is read from the storage unit 23, output from the network I/F 24 to the network 10 (FIG. 1), and transmitted to the client having issued the request. The content transmitted from another client is received by the network I/F 24 and stored in the storage unit 23.

When the client requests transmission of content or deletion of stored content, the server 8 acknowledges the request and receives and stores the content transmitted from the client or deletes the stored content.

Next, a content search method according to an embodiment of the present invention, which is for use in the home network system, will be described.

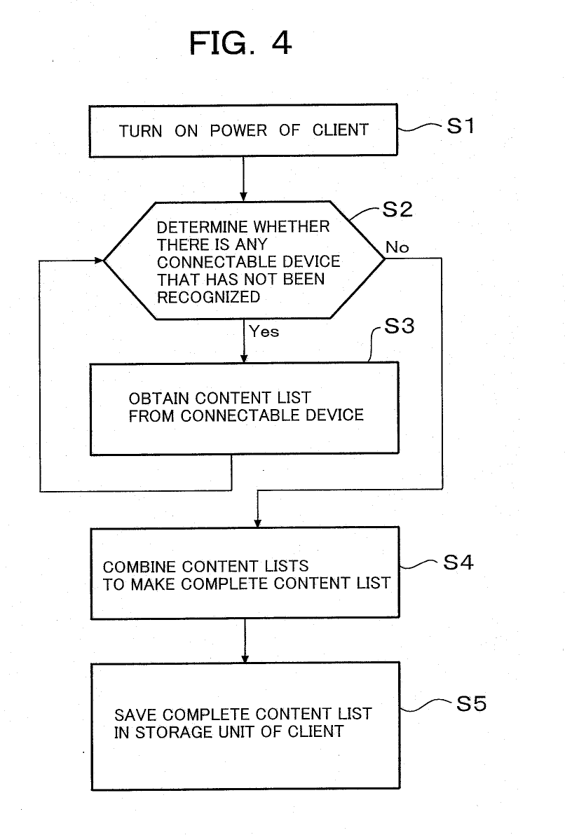

FIG. 4 is a flowchart showing the operation upon activation of a client shown in FIG. 1. The client is the TV receiver 1, 2, or 5 or the PC 4 connected to the network 10 shown in FIG. 1.

Referring to FIG. 4, when power of the client is turned on (when the power supply 18 shown in FIG. 2 or the power supply 27 shown in FIG. 3 is turned on) (step S1), the client 1 obtains content lists from all the other devices connected to the network 10 (FIG. 1) to which this client is connected. That is, the client determines whether a content list is obtained from each of the other devices (S2). If there is a device from which the content list has not yet been obtained (affirmative in S2), the client requests this device to transmit a content list and obtains the content list (S3). The obtained content lists are stored in the storage unit 14 (or 23).

When the content lists are obtained from all the other devices (negative in S2), the client reads the content lists of all the devices, including the content list of the client, from the storage unit 14 (or 23) and combines the content lists to make a complete content list (S4). The complete content list is stored in the storage unit 14 (or 23) for later use (S5).

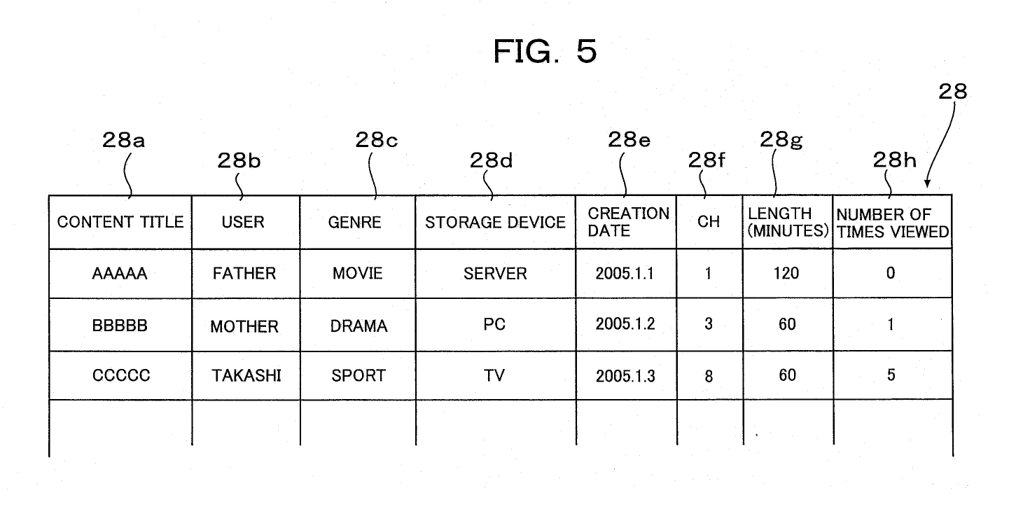

FIG. 5 schematically shows a specific example of the complete content list (hereinafter simply referred to as the “content list”) created in this manner.

Referring to FIG. 5, the content list includes eight content attributes, namely, “content title” 28a, “user” 28b, “genre” 28c, “storage device” 28d, “creation date” 28e, “channel (CH)” 28f, “length (minutes)” 28g, and “number of times viewed” 28h.

If content is a broadcast program, the attributes “content title” 28a, “genre” 28c, “creation date” 28e, “CH” 28f, and “length (minutes)” 28g are obtained from electronic program guide (EPG) information superimposed on a broadcast signal or information obtained from a log at the time of recording. The attribute “content title” 28a indicates the title of a program; the attribute “genre” 28c indicates the genre of content, such as movie, drama, sport, or the like; the attribute “creation date” 28e indicates the broadcast date of the program; the attribute “CH” 28f indicates the broadcasting channel name; and the attribute “length (minutes)” 28g indicates the broadcast duration in units of minutes.

If content is a piece of content obtained from a removable medium, the attribute “content title” 28a indicates, for example, the title of the content entered by the user; the attribute “genre” 28c indicates, for example, the genre of the content entered by the user; the attribute “creation date” 28e indicates, for example, the date on which the content is captured and recorded with a camcorder; and the attribute “CH” 28f is not recorded.

The attribute “user” 28b is generally a user that has operated the storage unit 14 or 23 to store the content. On the basis of the operation, a user name such as “father”, “mother”, or “Takashi” is entered since this takes place inside the house. When another user stores the content instead of the user requesting storage of the content, the name of the user requesting the storage of the content may be entered as the user name.

The attribute “storage device” 28d indicates a device storing the content. When content is stored in the storage unit 14 or 23 of a device, information indicating the device (device information) is added as storage device information and stored together with the content title and the like in the content list. When transmitting the content list to another device, the device information is also transmitted. The client having received the content list and the device information registers the device information as the attribute “storage device” 28d in the content list.

The attribute “number of times viewed” indicates the number of times the user has viewed the content, that is, the total number of times the user has viewed the content on each client since the content was obtained.

When each client obtains all the content lists on the network 10 (FIG. 1) (negative in S2 in FIG. 4) and combines the content lists to make a complete content list (S4 in FIG. 4), the client generates information about a content search screen on the basis of the content list. In response to a request for content search issued by operating the remote controller 12 (FIG. 2), the mouse 20 or the keyboard 22 (FIG. 3), the content search screen is displayed on the information display unit 13 (FIG. 2) or the display 21 (FIG. 3).

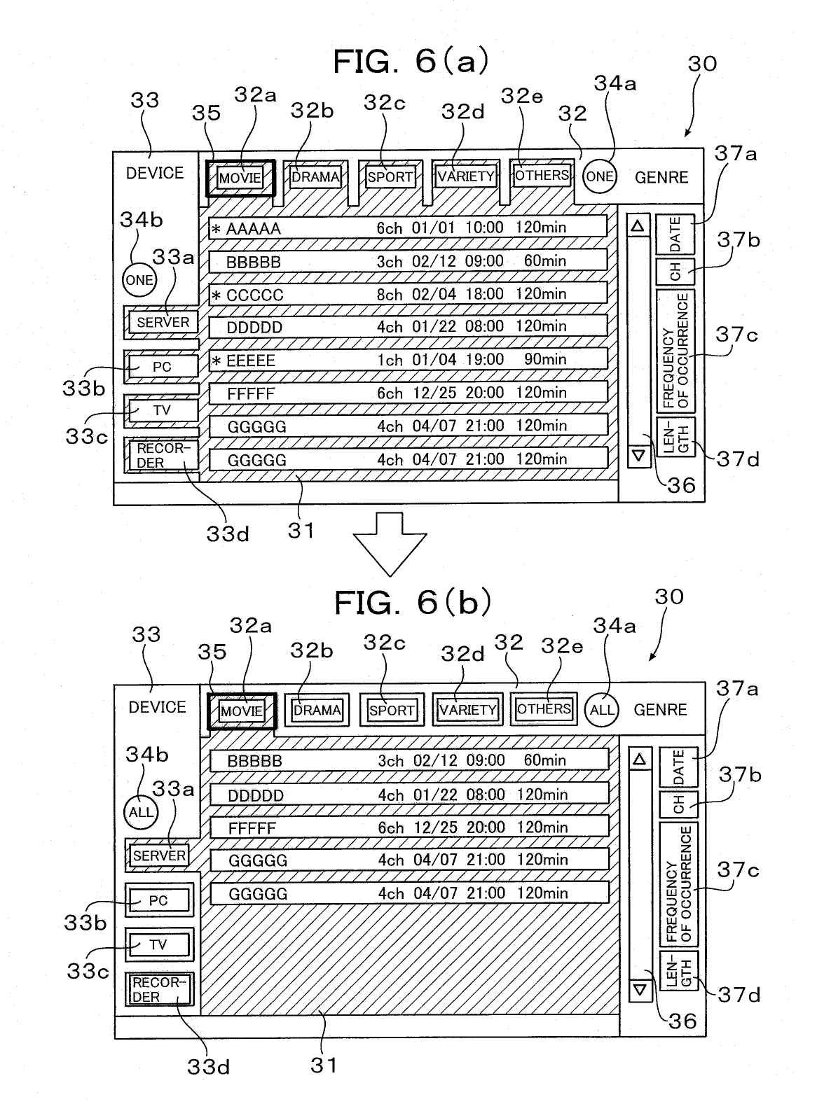

Next, the content search screen and its screen operation in this embodiment will be described. FIG. 6 shows a first specific example of a content search screen. Specifically, FIG. 6 shows a content search screen 30, a content list display area 31, a genre display area 32, genre selection buttons 33a to 33d, a device display area 33, device selection buttons 33a to 33e, one/all selection buttons 34a and 34b, a cursor 35, a scrollbar 36, a date sorting button 37a, a channel (CH) sorting button 37b, a frequency-of-occurrence sorting button 37c, and a length sorting button 37d.

Referring to FIG. 6, the content search screen 30 enables the user to conduct a content search using the attributes “genre” and “storage device” from among the content attributes shown in FIG. 5.

The rectangular content list display area 31 is set at the center of the content search screen 30. The genre display area 32 having the genre selection buttons 32a to 32e for conducting a content search using the attribute “genre”, which is one of the content attributes, is set above the content list display area 31. The device display area 33 having the device selection buttons 33a to 33d for conducting a content search using the attribute “storage device”, which is one of the content attributes, is set on the left side. The genre display area 32 additionally has the one/all selection button 34a, and the device display area 33 additionally has the one/all selection button 34b.

FIG. 6(a) shows the initial state of the content search screen 30. In this state, tabs (the number of which corresponds to the number of genre selection buttons) are displayed so as to protrude from the top side of the content list display area 31 into the genre display area 32. On the tabs, the genre selection button 32a for the genre “movie”, the genre selection button 32b for the genre “drama”, the genre selection button 32c for the genre “sport”, the genre selection button 32d for the genre “variety”, and the genre selection button 32e for the genre “others” are displayed. When the genre selection buttons are displayed on the tabs in this manner, it means that the genre selection buttons are selected. Therefore, all the genre selection buttons 32a to 32e are selected in FIG. 6(a).

The one/all selection button 34a is operated to switch the screen between the state in which all the genre selection buttons 32a to 32e are selected and the state in which the genre selection buttons 32a to 32e are selected one at a time. As shown in FIG. 6(a), when all the genre selection buttons 32a to 32e are selected, this state has been selected by the one/all selection button 34a, which displays “one”. When “one” is displayed on the one/all selection button 34a in this manner, currently all the genre selection buttons 32a to 32e are selected. When the one/all selection button 34a is operated in this state, the state is switched and the genre selection buttons 32a to 32e are selected one at a time.

Referring to FIG. 6(a), tabs (the number of which corresponds to the number of device selection buttons) are displayed so as to protrude from the left side of the content list display area 31 into the device display area 33. On the tabs, the device selection button 33a for the device “server (server 8 shown in FIG. 1)”, the device selection button 33b for the device “PC (PC 4 shown in FIG. 1)”, the device selection button 33c for the device “TV (e.g., the TV receiver 1 shown in FIG. 1)”, and the device selection button 33d for the device “recorder (e.g., the recorder 3 shown in FIG. 1)” are displayed. When the device selection buttons are displayed on the tabs in this manner, it means that the device selection buttons are selected. Therefore, all the device selection buttons 33a and 33d are selected in FIG. 6(a).

Similarly, the one/all selection button 34b is operated to switch the screen between the state in which all the device selection buttons 33a to 33d are selected and the state in which the device selection buttons 33a to 33d are selected one at a time. As shown in FIG. 6(a), when all the device selection buttons 33a to 33d are selected, this state has been selected by the one/all selection button 34b, which displays “one”. When “one” is displayed on the one/all selection button 34b in this manner, currently all the device selection buttons 33a to 33d are selected. When the one/all selection button 34b is operated in this state, the state is switched and the device selection buttons 33a to 33d are selected one at a time.

In the state shown in FIG. 6(a) in which all the genre selection buttons 32a to 32e and all the device selection buttons 33a to 33d are selected, a content list of pieces of content regarding all the genres and all the devices, namely, all information about the content list stored in the storage unit 14 or 23, is selected, and the content list is displayed in the content list display area 31. In this case, when the number of pieces of content on the list is great, information about all the pieces of content cannot be displayed in the content list display area 31. By scrolling the scrollbar 36, the content list is scrolled upward/downward to display hidden part of the content list.

Information about the content list displayed in the content list display area 31 includes, for example, the content titles under the attribute “content title” 28a shown in FIG. 5, the broadcasting channel names under the attribute “CH” 28f, the creation dates under the attribute “creation date” 28e, and the broadcast durations under the attribute “length (minutes)” 28g.

On the right side of the content search screen 30, the date sorting button 37a for sorting content information displayed in the content list display area 31 and setting the sequence of the information in ascending order of creation date, the CH sorting button 37b for setting the sequence of the information in ascending order of channel, for example, the frequency-of-occurrence sorting button 37c for setting the sequence of the information in order of frequency of viewing, and the length sorting button 37d for setting the sequence of the information in order of broadcast duration, e.g., in descending order of broadcast duration, are provided.

In this manner, for example, the cursor 35 is displayed in bold on the content search screen 30. The cursor 35 is movable by operating the remote controller 12 (FIG. 2), the mouse 20 or the keyboard 22 (FIG. 3). In the genre display area 32 where all the selection buttons 32a to 32e are selected, the cursor 35 does not function to select any of the selection buttons. Similarly, in the device display area 33 where all the selection buttons 33a to 33d are selected, the cursor 35 does not function to select any of the selection buttons. It should be noted, however, that when the cursor 35 is focused on any of the pieces of content information in the content list display area 31 to select that piece of content and when the remote controller 12, the mouse 20, or the keyboard 22 is operated to confirm the selection, the selected content is displayed on the information display unit 13 (FIG. 2) or the display 21 (FIG. 3). In this case, when this piece of content is stored in the storage unit 14 or 23 of the client displaying this content search screen, the content is read from the storage unit 14 or 23 and displayed on the information display unit 13 (FIG. 2) or the display 21 (FIG. 3). However, when this piece of content is stored in the storage unit 14 or 23 of another device, a request for the content is issued via the network 10 (FIG. 1) to the device having the content, and the content is obtained from the device and displayed on the information display unit 13 or the display 21.

Referring to FIG. 6(a), when the date sorting button 37a is selected by the cursor 35 and confirmed in the above-described manner, the content information is sorted by creation date in ascending order. When the CH sorting button 37b is selected and confirmed, the content information is sorted by channel in ascending order. When the frequency-of-occurrence sorting button 37c is selected and confirmed, the content information is sorted by frequency of viewing in descending order. When the length sorting button 37d is selected and confirmed, the content information is sorted by broadcast duration in descending order. Content obtained from the above-described removable medium falls under the genre “others”, and no “CH” is set for this content. When the CH sorting button 37b is selected and confirmed in the case of such content, for example, the content is arranged at the end of the content list. Needless to say, the user can arbitrarily set a channel for such content. In this case, the content is treated similarly to a broadcast program.

When the one/all selection button 34a is selected or when one of the genre selection buttons 32a to 32e is selected in the genre display area 32 on the content search screen shown in FIG. 6(a), one of the genre selection buttons 32a to 32e is selected and confirmed in the genre display area 32, as shown in FIG. 6(b). When the one/all selection button 34b is selected in the device display area 33 on the content search screen shown in FIG. 6(a), one of the device selection buttons 33a to 33d is selected and confirmed in the device display area 33, as shown in FIG. 6(b).

FIG. 6(b) shows the content search screen 30 in which the genre selection button 32a for the genre “movie” is selected in the genre display area 32, and the device selection button 33a for the device “server” is selected in the device display area 33. In this selection state, the genre selection button 32a for “movie” is selected and confirmed under the attribute “genre”, and the device selection button 33a for “server” is selected and confirmed under the attribute “storage device”. When the one/all selection button 34a is selected and confirmed in the state shown in FIG. 6(a), the genre selection button 32a for “movie” is selected and confirmed under the attribute “genre”, and the device selection button 33a for “server” is selected and confirmed under the attribute “storage device”, as has been described above. The genre selection button 32a for “movie” is displayed on the tab protruding from the content list display area 31, whereas the other genre selection buttons 32b to 32e in the genre display area 32 are independently and separately displayed. By moving the cursor 35, one of the genre selection buttons 32b to 32e can be selected and confirmed. Similarly, when the one/all selection button 34b is selected and confirmed in the state shown in FIG. 6(a), the device selection button 33a for “server” is displayed on the tab protruding from the content list display area 31, whereas the other genre selection buttons 33b to 33d in the device display area 33 are independently and separately displayed. By moving the cursor 35, one of the genre selection buttons 33b to 33d can be selected and confirmed.

In this state, a content list of pieces of content whose genre is “movie” and which are stored in the server 8 (FIG. 1) is displayed in the content list display area 31. That is, between the different attributes “genre” and “storage device”, pieces of content that belong to the genre indicated by the selected genre selection button and that are stored in the storage device indicated by the selected device selection button are to be searched in the content list display area 31.

As shown in FIG. 6(b), when one of the genre selection buttons 32a to 32e is selected, the one/all selection button 34a indicates “all”. When the one/all selection button 34a is operated in this state, the state is switched and all the genre selection buttons 32a to 32e are selected. The same applies to the one/all selection button 34b in the device display area 33 regarding the device selection buttons 33a to 33d.

The other portions shown in FIG. 6(b) are the same as those shown in FIG. 6(a), and repeated descriptions thereof are omitted to avoid redundancy.

As has been described above, in this specific example, the attributes “genre” and “storage device” serving as two search criteria are simultaneously displayed on the same screen, based on which the search criteria are set. Therefore, the search criteria can be easily set. Since the already-set search criteria are displayed in the set state, the search criteria can be checked at all times. Accordingly, the search criteria can be set without errors.

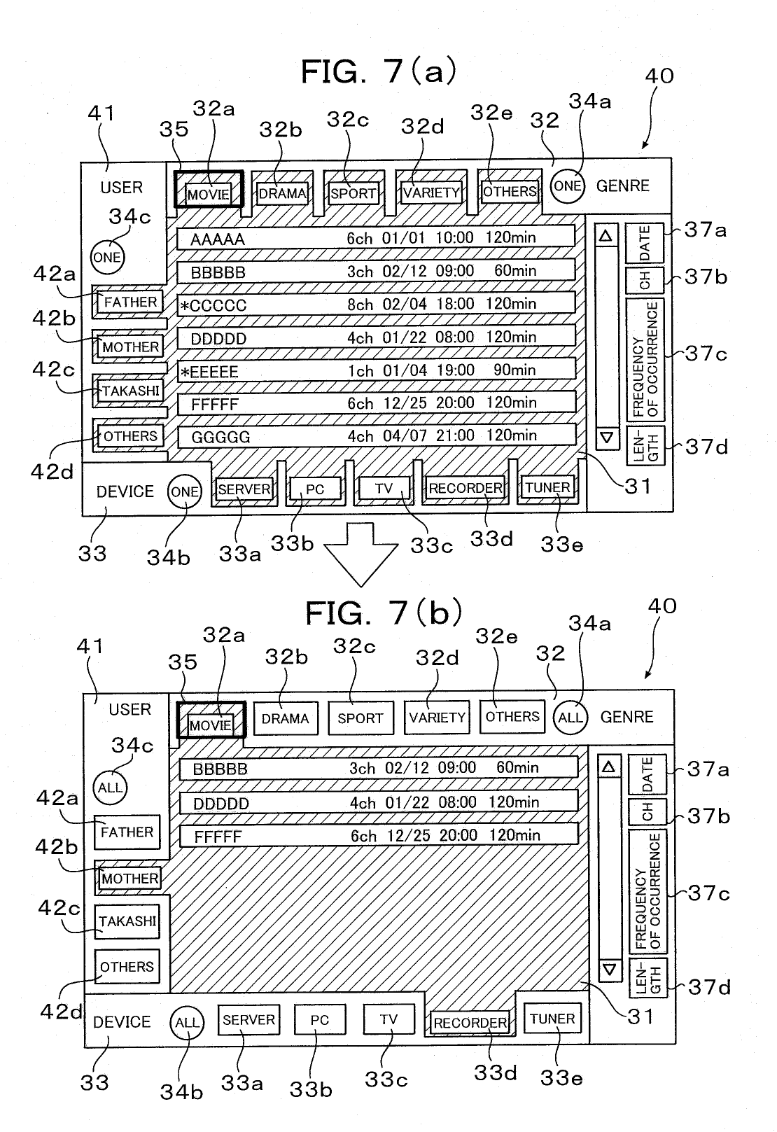

FIG. 7 shows a second specific example of a content search screen. Specifically, FIG. 7 shows a device selection button 33e, a one/all selection button 34c, a content search screen 40, a user display area 41, and user selection buttons 42a to 42d. Portions in FIG. 7 corresponding to those in FIG. 6 are given the same reference numerals, and repeated descriptions thereof are omitted to avoid redundancy. Also, reference numerals of some of the portions in FIG. 7 corresponding to those in FIG. 6 are omitted.

Referring to FIG. 7, the content search screen 40 has, besides the attributes “genre” and “storage device” in the specific example shown in FIG. 6, the additional attribute “user”. That is, the content search screen 40 has these three attributes serving as content search criteria. The device display area 33 is arranged below the content list display area 31. In contrast to the content search screen 30 shown in FIG. 6, the device selection button 33e for the device “tuner” is added in FIG. 7. The user display area 41 corresponding to the attribute “user” is arranged at the left of the content list display area 31. The user display area 41 has the user selection button 42a for the user “father”, the user selection button 42b for the user “mother”, the user selection button 42c for the user “Takashi”, the user selection button 42d for the user “others”, and the one/all selection button 34c.

FIG. 7(a) shows the state in which all the genre selection buttons 32a to 32e, all the device selection buttons 33a to 33e, and all the user selection buttons 42a to 42d are selected and confirmed in the genre display area 32, the device display area 33, and the user display area 41, respectively. Accordingly, a content list of pieces of content regarding all the genres, all the devices, and all the users, namely, all information about the content list stored in the storage unit 14 (FIG. 2) or 23 (FIG. 3), is selected, and the content list is displayed in the content list display area 31.

As in the specific example shown in FIG. 6, when the one/all selection button 34a is selected in the genre display area 32 or when the one/all selection button 34b is selected in the device display area 33 on the content search screen shown in FIG. 7(a), one of the genre selection buttons 32a to 32e is selected and confirmed in the genre display area 32, and one of the device selection buttons 33a to 33e is selected and confirmed in the device display area 33, as shown in FIG. 7(b). When the one/all selection button 34c is selected in the user display area 41 on the content search screen shown in FIG. 7(a), one of the user selection buttons 42a to 42d is selected and confirmed in the user display area 41, as shown in FIG. 7(b). The user selection button selected and confirmed from among the user selection buttons 42a to 42d is displayed on the tab protruding from the content list display area 31. When the one/all selection button 34c in the user display area 41 is selected and confirmed in the state shown in FIG. 7(a), the user selection button 42a for the user “father”, for example, is displayed on the tab protruding from the content list display area 31, and the other user selection buttons 42b to 42d in the user display area 41 are displayed independently. By moving the cursor 35, one of the user selection buttons 42b to 42d can be selected and confirmed.

In the state shown in FIG. 7(b), a content list of pieces of content whose genre is “movie”, whose user is “mother”, and which are stored in the recorder 3 (FIG. 1) is displayed in the content list display area 31. That is, between the different attributes “genre”, “storage device”, and “user”, pieces of content that belong to the genre indicated by the selected genre selection button, that are of the user indicated by the selected user selection button, and that are stored in the storage device indicated by the selected device selection button are to be searched in the content list display area 31.

As shown in FIG. 7(b), when one of the user selection buttons 42a to 42d is selected, the one/all selection button 34c indicates “all”. When the one/all selection button 34c is operated in this state, all the user selection buttons 42a to 42d shown in FIG. 7(a) are selected.

As has been described above, even in this specific example, the attributes “genre”, “storage device”, and “user” serving as three search criteria are simultaneously displayed on the same screen, based on which the search criteria are set. Therefore, the search criteria can be easily set. Since the already-set search criteria are displayed in the set state, the search criteria can be checked at all times. Accordingly, the search criteria can be set without errors.

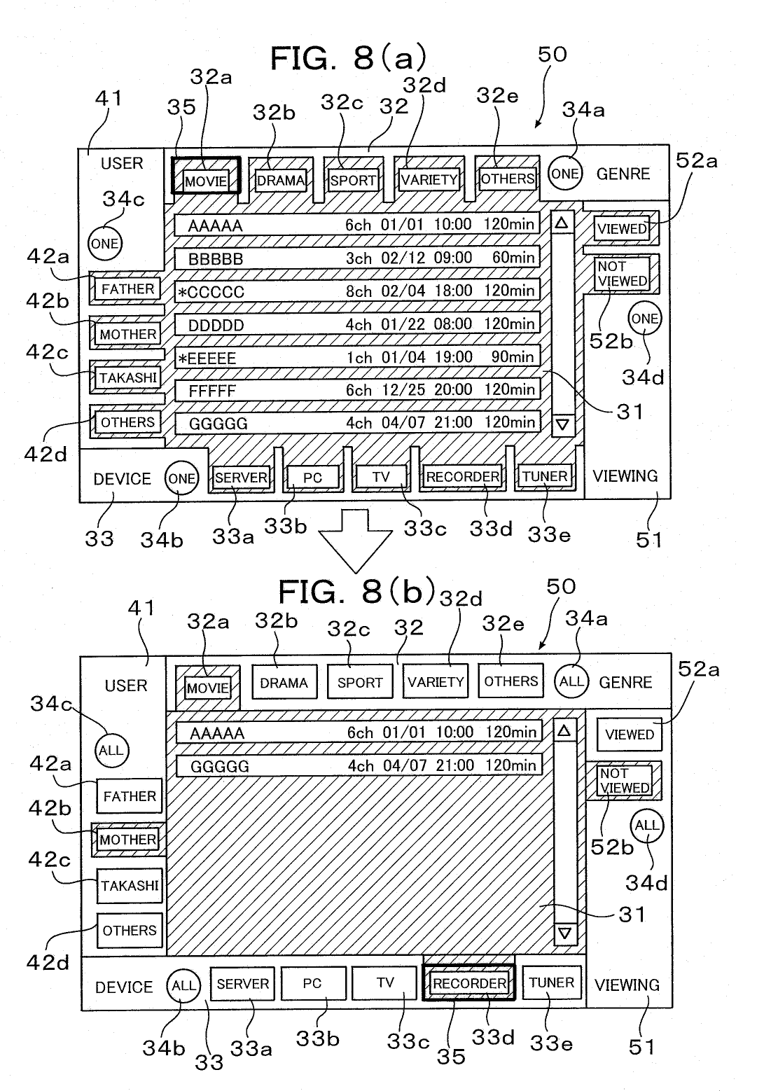

FIG. 8 shows a third specific example of a content search screen. Specifically, FIG. 8 shows a one/all selection button 34d, a content search screen 50, a viewing display area 51, and viewing selection buttons 52a and 52b. Portions in FIG. 8 corresponding to those in FIG. 7 are given the same reference numerals, and repeated descriptions thereof are omitted to avoid redundancy. Also, reference numerals of some of the portions in FIG. 8 corresponding to those in FIG. 7 are omitted.

Referring to FIG. 8, the content search screen 50 has, besides the attributes “genre”, “storage device”, and “user” in the specific example shown in FIG. 7, the additional attribute “viewing” based on the attribute “number of times viewed” 28h shown in FIG. 5. That is, the content search screen 50 has these four attributes serving as content search criteria. The “viewing” enables the user to set the search criteria “viewed” and “not viewed” on the basis of the attribute “number of times viewed” 28h shown in FIG. 5.

The positions of the genre display area 32, the device display area 33, and the user display area 41 are the same as those on the content search screen 40 shown in FIG. 7. The viewing display area 51 is arranged at the right of the content list display area 31. The viewing display area 51 has the “viewed” viewing selection button 52a, the “not viewed” viewing selection button 52b, and the one/all selection button 34d.

As in the other attribute display areas 32, 33, and 41, in the viewing display area 51, as shown in FIG. 8(a), when “all” is selected and confirmed by operating the one/all selection button 34d (“one” is displayed by the one/all selection button 34d in this case), both the “viewed” viewing selection button 52a and the “not viewed” viewing selection button 52b are displayed on the tabs protruding from the content list display area 31. Accordingly, pieces of content that have been viewed and pieces of content that have not been viewed yet are displayed in the content list in the content list display area 31.

When the one/all selection button 34d is operated in the viewing display area 51 on the content search screen 50 shown in FIG. 8(a), one of the viewing selection buttons 52a and 52b is selected, as shown in FIG. 8(b). In this case, the viewing selection button 52b is selected and confirmed. Thus, information about pieces of content that have not been viewed yet (zero time is indicated by the “number of times viewed” 28h in FIG. 5) is displayed in the content list in the content list display area 31. Needless to say, by selecting and confirming the viewing selection button 52a, information about pieces of content that have been viewed (i.e., viewed at least once) is displayed in the content list in the content list display area 31. By operating the one/all selection button 34d, the screen is switched to the state shown in FIG. 8(a).

Portions other than the aforementioned points are the same as those in the second embodiment shown in FIG. 7. The attributes “genre”, “storage device”, “user” and “viewing” serving as four search criteria are simultaneously displayed on the same screen, based on which the search criteria are set. Therefore, the search criteria can be easily set. Since the already-set search criteria are displayed in the set state, the search criteria can be checked at all times. Accordingly, the search criteria can be set without errors.

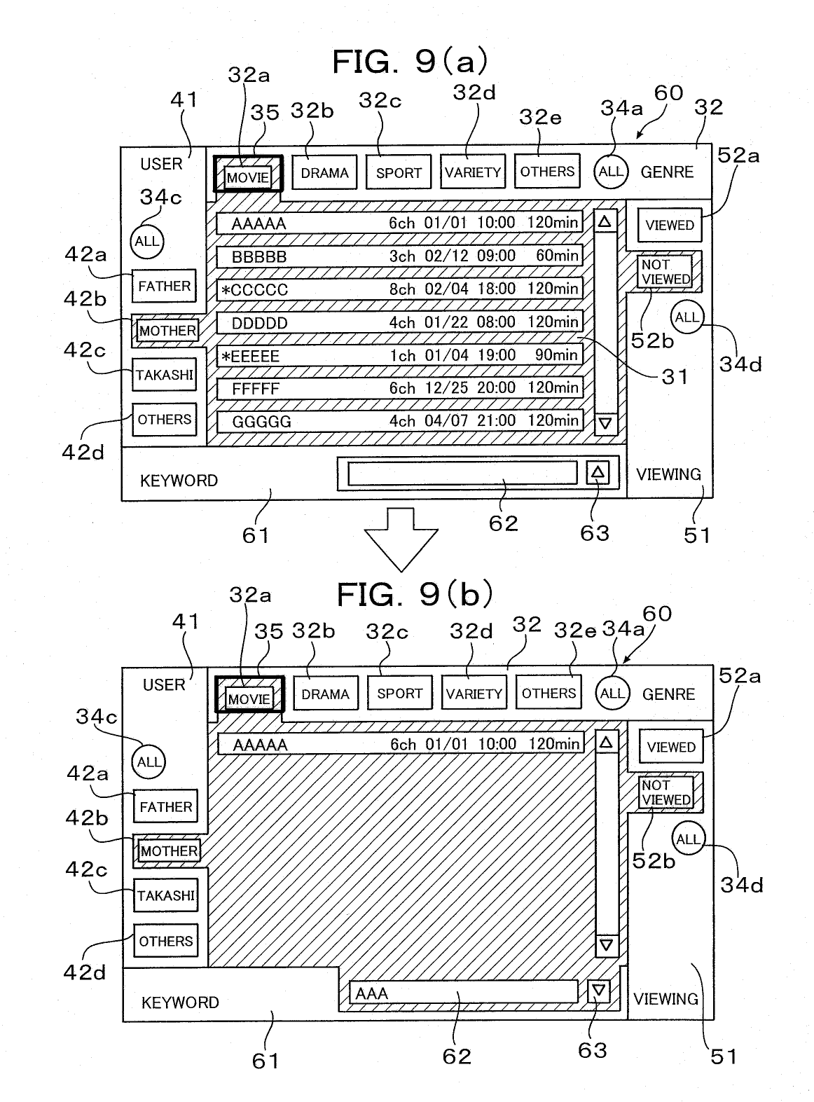

FIG. 9 shows a fourth specific example of a content search screen. Specifically, FIG. 9 shows a content search screen 60, a keyword display area 61, a keyword entering area 62, and a triangular symbol button 63. Portions in FIG. 9 corresponding to those in FIG. 8 are given the same reference numerals, and repeated descriptions thereof are omitted to avoid redundancy. Also, reference numerals of some of the portions in FIG. 9 corresponding to those in FIG. 7 are omitted.

Referring to FIG. 9(a), the content search screen 60 has, instead of the attribute “storage device” in the specific example shown in FIG. 8, “keyword” as a content search criterion. Thus, the keyword display area 61 including the keyword entering area 62 is arranged below the content list display area 31.

The keyword can be anything other than the “genre” 28c, “user” 28b, and “number of times viewed” 28h among the attributes shown in FIG. 5 since these attributes “genre” 28c, “user” 28b, and “number of times viewed” 28h are used in the genre display area 32, the user display area 41, and the viewing display area 51, respectively.

The keyword entering area 62 has the triangular symbol button 63. By entering a keyword in the keyword entering area 62 and operating the triangular symbol button 63, a content search is conducted using the entered keyword as the search criterion. In this manner, the entered keyword serves as a content search criterion. On the content search screen 60 shown in FIG. 9(b), the content search criteria include “movie” under the attribute “genre”, “mother” under the attribute “user”, “not viewed” under the attribute “viewing”, and the keyword “AAA”. A list of pieces of content that satisfy these search criteria is displayed in the content list display area 31.

By operating the triangular symbol button 63 in the state shown in FIG. 9(b), the keyword entering area 62 and the triangular symbol button 63 are separated from the content list display area 31, and the keyword in the keyword entering area 62 is removed from the search criteria.

A desired keyword can be directly entered in the keyword entering area 62 using the keyboard 22 or the remote controller 12.

The same advantages as those in the previous embodiments can be achieved by the fourth embodiment.

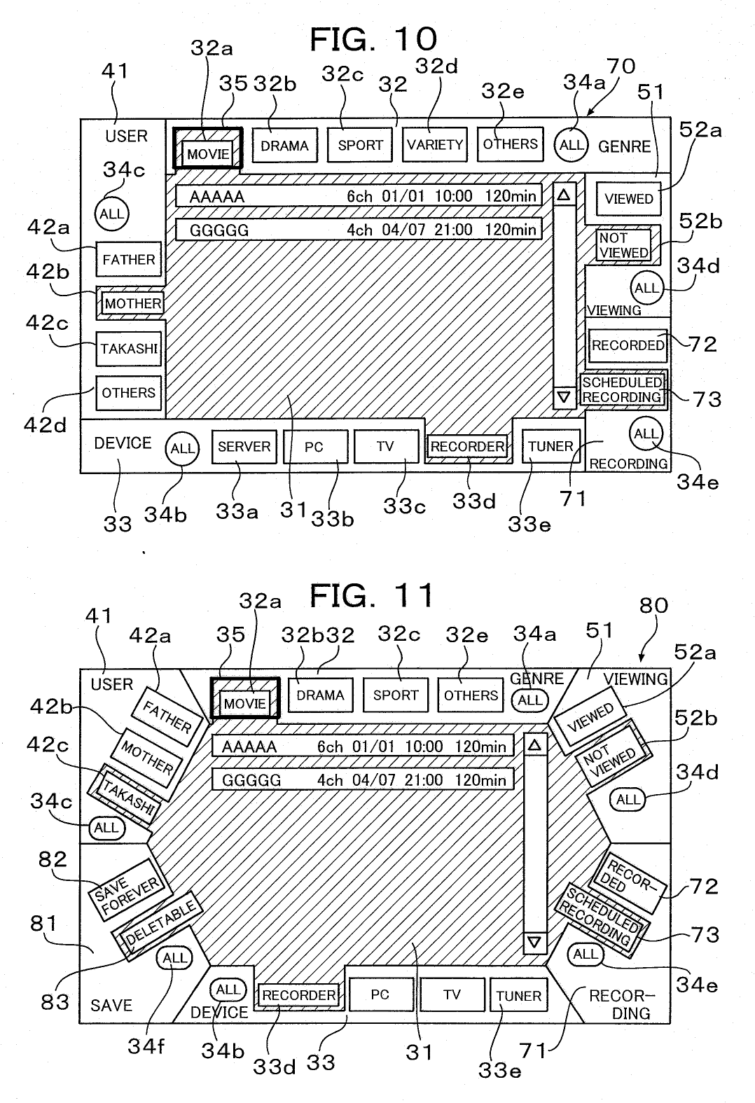

FIG. 10 shows a fifth specific example of a content search screen. Specifically, FIG. 10 shows a content search screen 70, a recording display area 71, and recording selection buttons 72 and 73. Portions in FIG. 10 corresponding to those in FIG. 8 are given the same reference numerals, and repeated descriptions thereof are omitted to avoid redundancy. Also, reference numerals of some of the portions in FIG. 10 corresponding to those in FIG. 8 are omitted.

Referring to FIG. 10, the content search screen 70 has, besides the attributes “genre”, “storage device”, “user” and “viewing” in the specific example shown in FIG. 8, the additional attribute “recording”. That is, the content search screen 70 has these five attributes serving as content search criteria. In this fifth specific example, the attribute “recording” indicating whether a piece of content is recorded or scheduled to be recorded is added to the content list shown in FIG. 5.

The positions of the genre display area 32, the device display area 33, and the user display area 41 are the same as those on the content search screen 50 shown in FIG. 8. The recording display area 71 having the “recorded” recording selection button 72, the “scheduled recording” recording selection button 73, and a one/all selection button 34e is arranged, for example, below the viewing display area 51 at the right of the content list display area 31.

As in the other attribute display areas 32, 33, 41, and 51, in the recording display area 71, when “all” is selected and confirmed by operating the one/all selection button 34e, the attribute “recording” is removed from the search criteria. When “one” is selected and confirmed, one of “recorded” and “scheduled recording” is selected as a search criterion depending on whether the “recorded” recording selection button 72 or the “scheduled recording” recording selection button 73 is selected.

Portions other than the aforementioned points are the same as those in the third embodiment shown in FIG. 8. The same advantages as those in the third embodiment can be achieved by the fifth embodiment.

FIG. 11 shows a sixth specific example of a content search screen. Specifically, FIG. 11 shows a content search screen 80, a save display area 81, and save selection buttons 82 and 83. Portions in FIG. 11 corresponding to those in FIG. 10 are given the same reference numerals, and repeated descriptions thereof are omitted to avoid redundancy. Also, reference numerals of some of the portions in FIG. 11 corresponding to those in FIG. 10 are omitted.

Referring to FIG. 11, the content search screen 80 has, besides the attributes “genre”, “storage device”, “user”, “viewing”, and “recording” in the specific example shown in FIG. 10, the additional attribute “save”. That is, the content search screen 80 has these six attributes serving as content search criteria. In this sixth specific example, besides the aforementioned attribute “recording”, the attribute “save” indicating whether a piece of content is saved forever or can be deleted is added to the content list shown in FIG. 5.

On the content search screen 80, the content list display area 31 has a hexagonal shape that is long in a longitudinal direction. For example, the genre display area 32 is arranged above the content list display area 31. The user display area 41 is arranged in the upper left corner. The save display area 81 is arranged in the lower left corner. The device display area 33 is arranged below the content list display area 31. The recording display area 71 is arranged in the lower right corner. The viewing display area 51 is arranged in the upper right corner. The save display area 81 has the “save forever” save selection button 82, the “deletable” save selection button 83, and a one/all selection button 34f.

As in the other attribute display areas 32, 33, 41, 51, and 71, in the save display area 81, when “all” is selected and confirmed by operating the one/all selection button 34f, the attribute “save” is removed from the search criteria. When “one” is selected and confirmed, one of “save forever” and “deletable” is selected as a search criterion depending on whether the “save forever” save selection button 82 or the “deletable” save selection button 83 is selected.

Portions other than the aforementioned points are the same as those in the fifth embodiment shown in FIG. 10. The same advantages as those in the fifth embodiment can be achieved by the sixth embodiment.

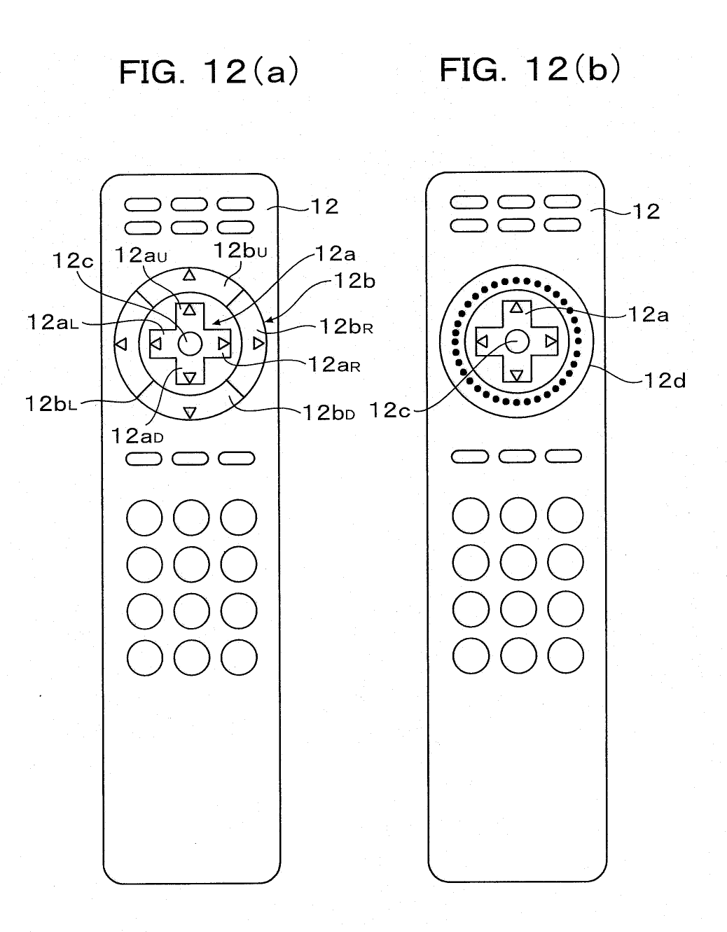

The remote controller 12 (FIG. 2) or the keyboard 22 (FIG. 3) has means for operating the above-described content search screen. With reference to FIGS. 12A and 12B, specific examples of such operating means are described using the remote controller 12 by way of example.

FIG. 12A shows a specific example of the remote controller 12. Specifically, FIG. 12A shows a cross cursor key 12a, a ring cursor key 12b, and a confirm key 12c. The cross cursor key 12a has an upward key 12a_{U}, a downward key 12a_{D}, a rightward key 12a_{R}, and a leftward key 12a_{L}. The ring cursor key 12b has an upward key 12b_{U}, a downward key 12b_{D}, a rightward key 12b_{R}, and a leftward key 12b_{L}.

Referring to FIG. 12A, the cross cursor key 12a and the ring cursor key 12b are arranged on an operating surface of the remote controller 12. The cross cursor key 12a has a cross shape defined by the upward key 12a_{U}, the downward key 12a_{D}, the rightward key 12a_{R}, and the leftward key 12a_{L}. The ring cursor key 12b having the upward key 12b_{U}, the downward key 12b_{D}, the rightward key 12b_{R}, and the leftward key 12b_{L} is arranged so as to enclose the cross cursor key 12a.

The inner cross cursor key 12a is operated to move the cursor within the same display area. The outer ring cursor key 12b is operated to move the cursor among different display areas. The confirm key 12c is operated to confirm a selection button selected by operating the cross cursor key 12a and the ring cursor key 12b.

For example, in the genre display area 32 on the content search screen 30 shown in FIG. 6(b), the cursor 35 is moved horizontally to select the selection buttons one at a time by operating the rightward key 12a_{R} and the leftward key 12a_{L} of the cross cursor key 12a. Accordingly, one of the genre selection buttons 32a and 32e is selected.

For example, on the content search screen 30 shown in FIG. 6(b), the cursor 35 is moved to the device display area 33 on the left side by operating the leftward key 12b_{L} of the ring cursor key 12b. By operating the upward key 12a_{U}, and the downward key 12a_{D} of the cross cursor key 12a, the cursor 35 is moved vertically in the device display area 33 to select the device selection buttons one at a time. Accordingly, one of the device selection buttons 33a to 33d is selected in FIG. 6(b). By operating the rightward key 12b_{R} of the ring cursor key 12b, the cursor 35 is moved to one of the date sorting button 37a, the CH sorting button 37b, the frequency-of-occurrence sorting button 37c, and the length sorting button 37d, which are arranged on the right side. By operating the upward key 12a_{U} and the downward key 12a_{D} of the cross cursor key 12a, the cursor 35 is moved vertically to select these selection buttons one at a time. Accordingly, one of the sorting buttons 37a to 37d is selected in FIG. 6(b).

On the content search screen 30 shown in FIGS. 6(a) and 6(b), the cursor 35 is moved to the content list display area 31 below the genre display area 32 by operating the downward key 12b_{D} of the ring cursor key 12b. On the content search screen 40 shown in FIGS. 7(a) and 7(b), the cursor 35 is moved to the device display area 33 below the content list display area 31 by further operating the downward key 12b_{D}. By operating the upward key 12b_{U} of the ring cursor key 12b on the content search screen 40 shown in FIGS. 7(a) and 7(b) in which the cursor 35 is positioned in the device display area 33, the cursor 35 is moved from the device display area 33 to the content list display area 31. By further operating the upward key 12b_{U}, the cursor 35 is moved from the content list display area 31 to the genre display area 32.

When the cursor 35 is positioned in the user display area 41 on the content search screen 30 or 40 shown in FIG. 6 or 7, the cursor 35 is moved from the user display area 41 to the content list display area 31 by operating the rightward key 12b_{R} of the ring cursor key 12b. By further operating the rightward key 12b_{R}, the cursor 35 is moved from the content list display area 31 to the display area where the sorting buttons 37a to 37d are displayed. In contrast, when the cursor 35 is positioned in the display area where the sorting buttons 37a to 37d are displayed, the cursor 35 is moved from this display area where the sorting buttons 37a to 37d are displayed to the content list display area 31 by operating the leftward key 12b_{L} of the ring cursor key 12b. By further operating the leftward key 12b_{L}, the cursor 35 is moved from the content list display area 31 to the user display area 41.

The cursor 35 moved to the content list display area 31 initially focuses on a piece of content that is arranged at the beginning of the content list.

The above description applies to the content search screens shown in FIGS. 7 to 9. For the content search screen 70 shown in FIG. 10, the ring cursor key 12b may have an additional selection button for designating the viewing display area 51 or the recording display area 71. For the content search screen 80 shown in FIG. 11, the ring cursor key 12b may have an additional selection button for designating the user display area 41 or the save display area 81 and an additional selection button for designating the viewing display area 51 or the recording display area 71.

FIG. 12B shows another specific example of the remote controller 12. Specifically, FIG. 12B shows a jog dial 12d. Portions in FIG. 12B corresponding to those in FIG. 12A are given the same reference numerals, and repeated descriptions thereof are omitted to avoid redundancy.

Referring to FIG. 12B, the specific example of the remote controller 12 has the jog dial 12d instead of the ring cursor key 12b of the remote controller 12 shown in FIG. 12A. By operating the jog dial 12d, the cursor can be moved in the same display area.

For example, when the jog dial 12d is rotated on the content search screen 30 shown in FIG. 6, the cursor 35 is moved horizontally in accordance with the rotating direction to select the genre selection buttons one at a time in the genre display area 32. Accordingly, one of the genre selection buttons 32a to 32e is selected in FIG. 6(b). The same applies to the case where the cursor 35 is positioned in the device display area 33 or in the area where the date sorting button 37a, the CH sorting button 37b, the frequency-of-occurrence sorting button 37c, and the length sorting button 37d are arranged. By rotating the jog dial 12d, the cursor 35 is moved vertically to select the device selection buttons or the sorting buttons one at a time. The same applies to the content search screens shown in FIGS. 7 to 11.

The cross cursor key 12a is similar to the ring cursor key 12b shown in FIG. 12A. The cursor 35 moved to the content list display area 31 initially focuses on a piece of content that is arranged at the beginning of the content list.

The keyboard 22 of the PC 4 has similar cursor operating means, a description of which is omitted to avoid redundancy.

Each of the content search screens described above has the scrollbar 36, as shown in FIGS. 6 to 11. The remote controller 12 has an additional operation key for operating the scrollbar 36, which is not shown in FIGS. 12A and 12B. In the case of the PC 4 (FIG. 1), the mouse pointer can be operated with the mouse 20 (FIG. 3). Accordingly, portions such as the scrollbar 36 that cannot be operated using the cursor 35 can be operated.

Other screen operations performed on the above-described content search screens will be described.

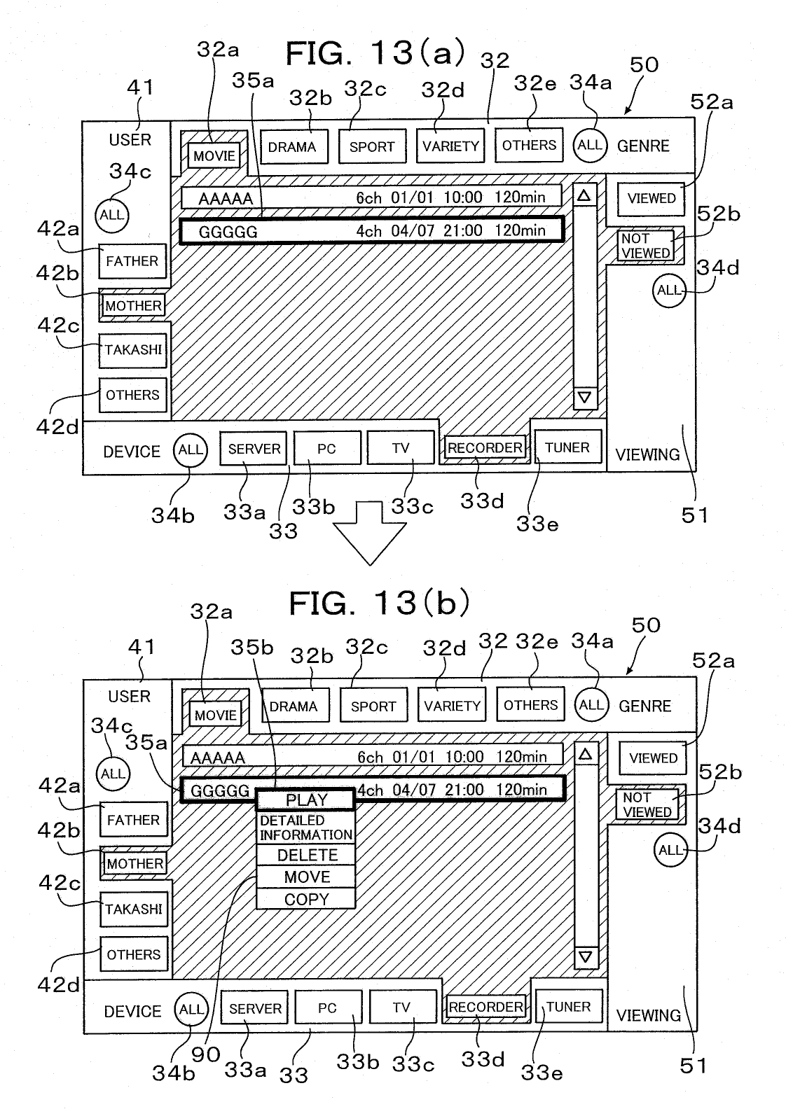

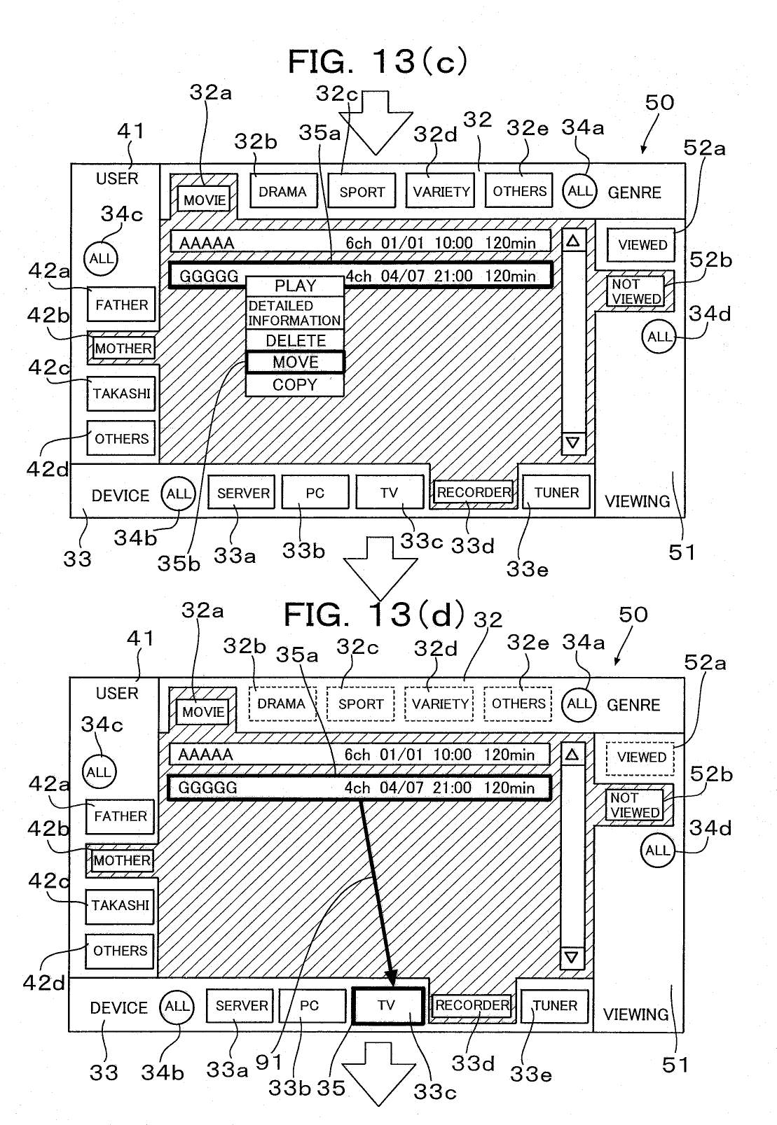

FIG. 13 shows a specific example of a screen operating method for operating the content search screen 50 shown in FIG. 8. Specifically, FIG. 13 shows cursors 35a and 35b, a mode menu 90, and an arrow 91. Portions in FIG. 13 corresponding to those in FIG. 8 are given the same reference numerals, and repeated descriptions thereof are omitted to avoid redundancy. Also, reference numerals of some of the portions in FIG. 13 corresponding to those in FIG. 8 are omitted.

FIG. 13(a) shows a state in which a piece of content (content with the content title “GGGGG”) displayed in the content list display area is selected on the content search screen 50 shown in FIG. 8(b). The selected content is focused by the cursor 35a.

By operating a menu button or the confirm key 12c of the remote controller 12 (FIGS. 2, 12A, and 12B) or the keyboard 22 (FIG. 3) in this display state, the mode menu 90 from which one of the modes “play”, “detailed information”, “delete”, “move” and “copy” is selectable is displayed in the content list display area 31, as shown in FIG. 13(b). In addition, the cursor 35b selecting one of these modes (the mode “play” is selected here) is displayed. The aforementioned selected content is continuously focused by the cursor 35a.

In the mode “play”, the selected content is played and displayed on the information display unit 13 (FIG. 2) or the display 21 (FIG. 3). In the mode “detailed information”, detailed information about the selected content is displayed on the information display unit 13 or the display 21. In the mode “delete”, the selected content is deleted. In the mode “move”, a changeable attribute, such as the storage location of the selected content (the storage unit 14 (FIG. 2), the storage unit 23 (FIG. 3), or the server 8 (FIG. 1)) or the user, is changed. In the mode “copy”, the selected content is copied in another client or the server 8 or for another user.

By operating the cross cursor key 12a or the jog dial 12d of the remote controller 12 shown in FIG. 12A or 12B in the display state of the content search screen 50 shown in FIG. 13(b), the cursor 35b is moved vertically in the mode menu 90 to select the desired mode. FIG. 13(c) shows a state in which the mode “move” is selected.

To move the content to another selected storage device in the display state of the content search screen 50 shown in FIG. 13(c), for example, the downward key 12b_{D} of the ring cursor key 12b of the remote controller 12 shown in FIG. 12A is operated. As a result, as shown in FIG. 13(d), the mode menu 90 disappears, one of the device selection buttons (the “TV” device selection button 33c in this case) is focused and selected by the cursor 35 in the device display area 33, and the arrow 91 pointing from the content selected by the cursor 35a to the device selection button 33c focused by the cursor 35 in the device display area 33 is displayed, thereby showing the destination of the content. By operating the cross cursor key 12a or the jog dial 12d of the remote controller 12 shown in FIG. 12A or 12B in this state, another one of the device selection buttons 33a to 33e is selected, and the direction indicated by the arrow 91 is also changed.

In this state, the selection buttons “genre” and “viewing” are inactive (indicated by broken lines). Since these attributes cannot be changed by user operation in this state, these attributes are not selectable as the destination.

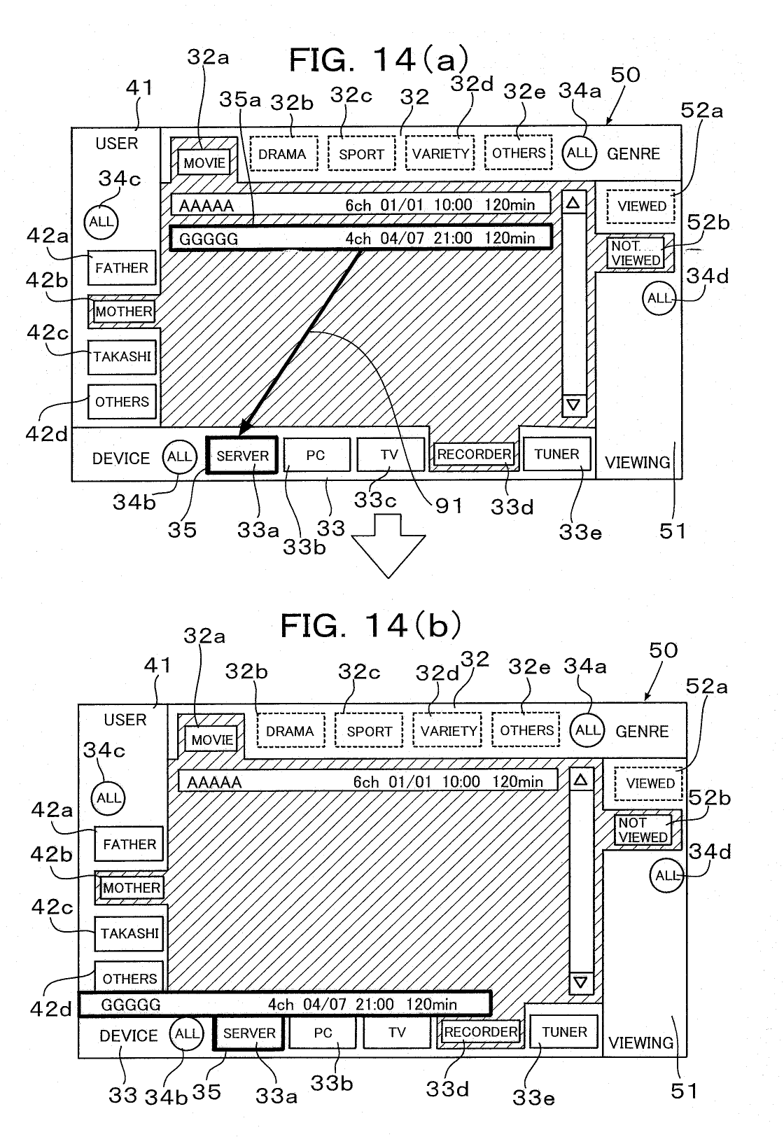

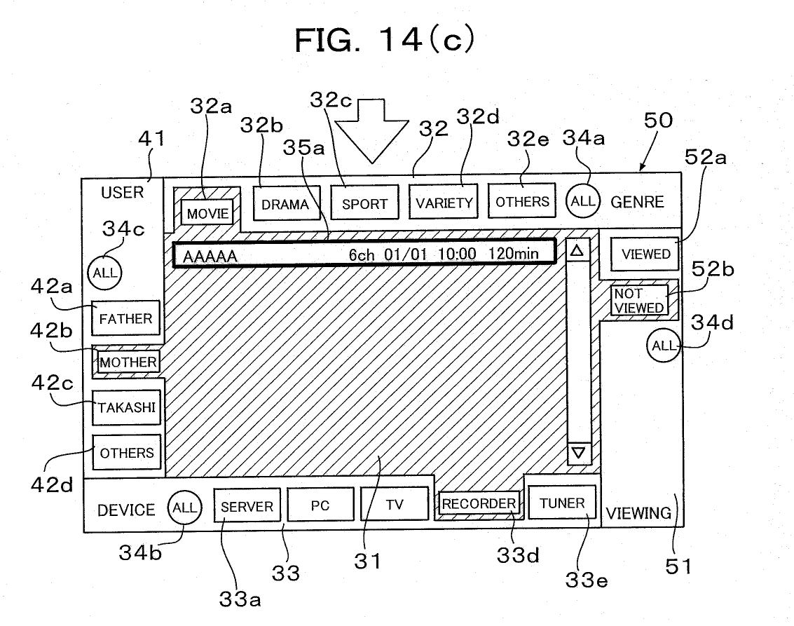

FIG. 14 shows changes in the content search screen 50 subsequent to the display state shown in FIG. 13(d) by operating the screen. Portions in FIG. 14 corresponding to those in FIG. 13 are given the same reference numerals, and repeated descriptions thereof are omitted to avoid redundancy.

FIG. 14(a) shows a state in which, for example, the “server” device selection button 33a is selected in the device display area 33 by operating the cross cursor key 12a or the jog dial 12d of the remote controller 12 shown in FIG. 12A or 12B in the display state shown in FIG. 13(d). The cursor 35 focuses on the device selection button 33a, and the arrow 91 points to the device selection button 33a.

For example, by operating the confirm key 12c of the remote controller 12 shown in FIGS. 12A and 12B in this display state, the content information focused by the cursor 35a in the content list is moved toward the selected device selection button 33a, as shown in FIG. 14(b). When the content information focused by the cursor 35a disappears as if it were absorbed by the device selection button 33a, one of the remaining piece(s) of content is focused by the cursor 35a in the content list in the content list display area 31, as shown in FIG. 14(c). Since there is only one remaining piece of content “AAAAA”, this content is focused by the cursor 35a. When there are two or more than two pieces of remaining content, the piece of content displayed at the top is focused.

In this manner, the content selected in the content list is moved and saved in a designated client or server (the server 8 in this case).

In the screen operations shown in FIGS. 13 and 14, since the attribute “recorder” is selected in the device display area 33, pieces of content in the content list in the content list display area 31 are those stored in the recorder with the DMP function 3 shown in FIG. 1. Among these pieces of content, the content “GGGGG” is moved to, for example, the TV receiver 1 shown in FIG. 1. In the device display area 33, the “recorder” device selection button 33d is selected to set the search criterion “recorder” under the attribute “storage device”. The content “GGGGG”, which is moved from the recorder with the DMP function 3 to the TV receiver 1, is deleted from the content list in the content list display area 31.

In this manner, any client can move content stored in the server 8 or an arbitrary client to another arbitrary client or the server 8. The storage location of the content can be appropriately determined, such as moving the content to the server 8 according to the storage state of the content in the client or storing the content in a different location according to the attributes.

Although the above description is made with reference to FIGS. 13 and 14 using the content search screen 50 shown in FIG. 8 by way of example, the same applies to the other content search screens described above.

The content search screens 30 and 40 shown in FIGS. 6 and 7 are each provided with the sorting buttons 37a to 37d for sorting pieces of content in the content list displayed in the content list display area 31. Next, the pieces of content in the content list are sorted.

FIG. 15 shows sorting of pieces of content in a content list on the content search screen 40 shown in FIG. 7 by way of example. Portions in FIG. 15 corresponding to those in FIG. 7 are given the same reference numerals, and repeated descriptions thereof are omitted to avoid redundancy.

FIG. 15(a) shows a state in which the date sorting button 37a is focused and selected by the cursor 35. In this case, pieces of content in a content list displayed in the content list display area 31 are sorted by creation date. Specifically, the pieces of content are sorted in the following order: the content “AAAAA” (creation date is January 1, 10:00), the content “EEEEE” (creation date is January 4, 19:00), the content “DDDDD” (creation date is January 22, 8:00), . . .

By operating the cross cursor key 12a or the jog dial 12d of the remote controller 12 shown in FIG. 12A or 12B in this display state, the cursor 35 is moved to select the CH sorting button 37b. As a result, as shown in FIG. 15(b), the pieces of content in the content list displayed in the content list display area 31 are sorted by channel in descending order, namely, in the following order: the content “EEEEE” of 1 CH, the content “BBBBB” of 3 CH, . . . Pieces of content that have the same channel are sorted in a predetermined order, such as by creation date, frequency of occurrence (the number of times viewed), or length.

The same applies to the case where the frequency-of-occurrence sorting button 37c or the length sorting button 37d is operated. By selecting the frequency-of-occurrence sorting button 37c or the length sorting button 37d, the pieces of content are sorted by the number of times viewed or length.

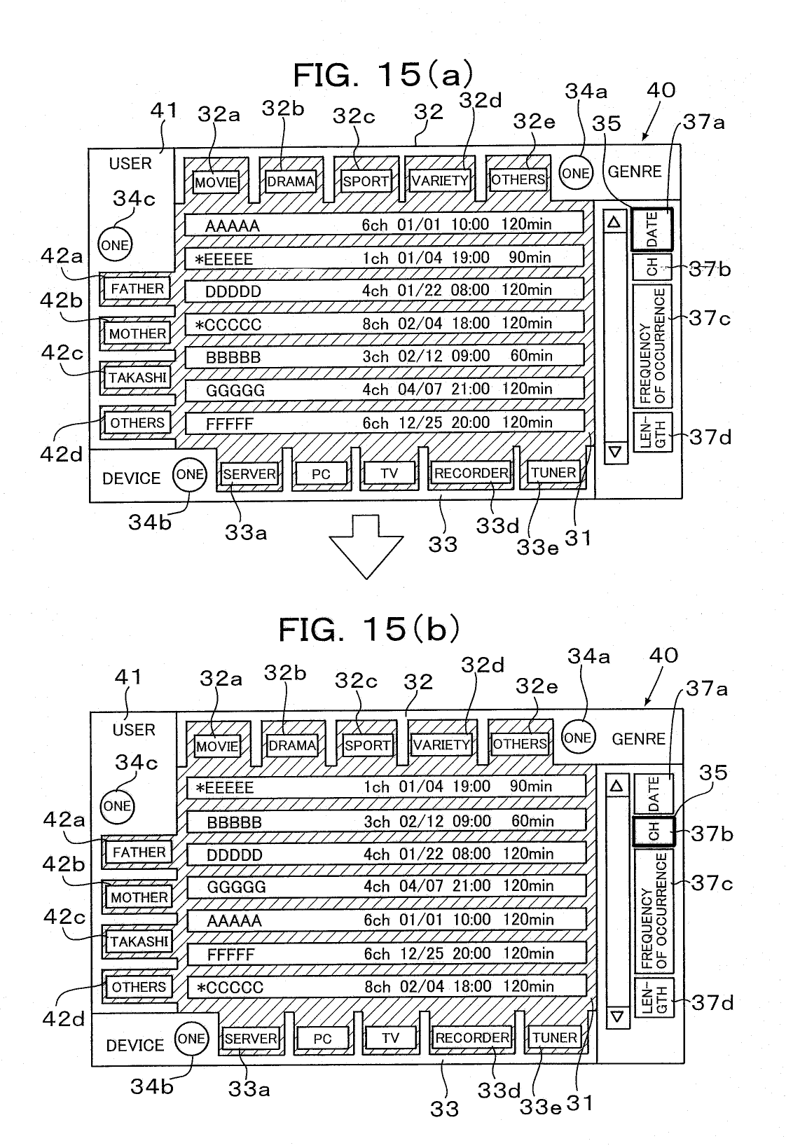

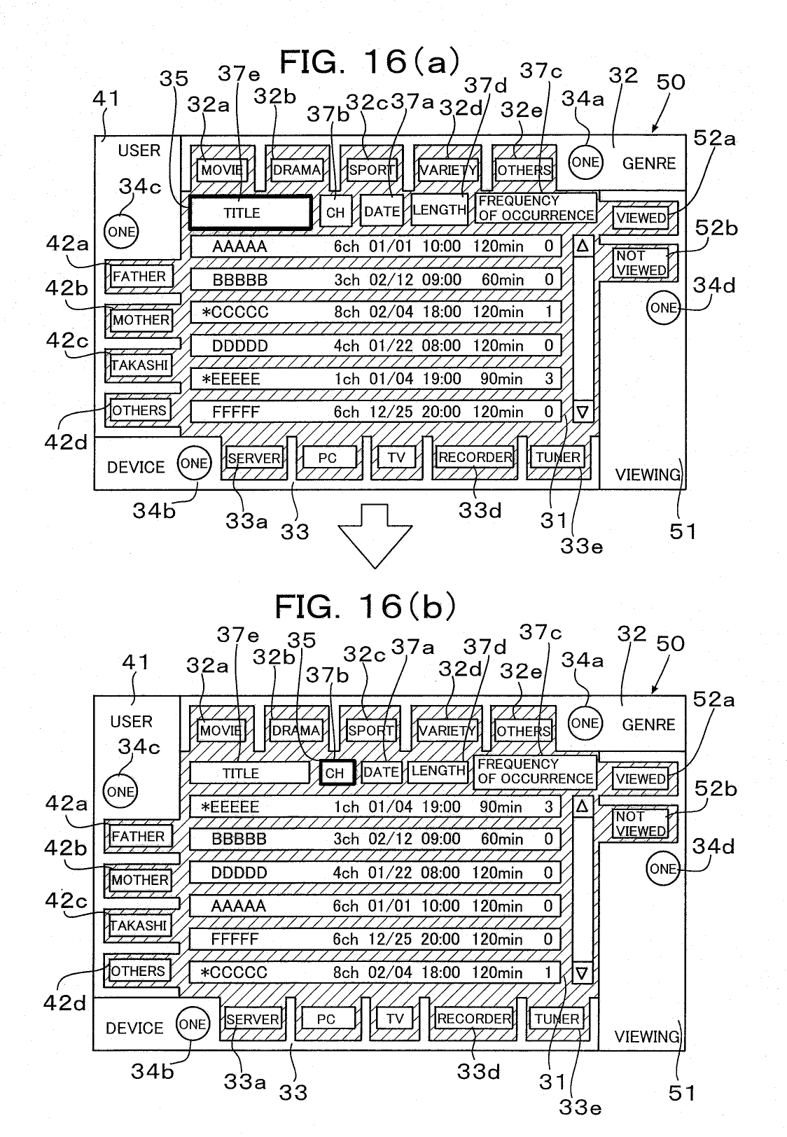

FIG. 16 shows sorting of pieces of content in a content list on the content search screen 50 shown in FIG. 8 by way of example. Portions in FIG. 16 corresponding to those in FIG. 8 are given the same reference numerals, and repeated descriptions thereof are omitted to avoid redundancy.

Although the sorting buttons are not shown on the content search screen 50 shown in FIG. 8, the content search screen 50 may have, for example, a title sorting button 37e, the CH sorting button 37b, the date sorting button 37a, the length sorting button 37d, and the frequency-of-occurrence sorting button 37c, which are arranged in a row above the content list in the content list display area 31. The sequence of the sorting buttons corresponds to the sequence of the content attributes in the content list, namely, title, CH, creation date, length (minutes), and number of times viewed. The sorting buttons indicate the attribute names.

FIG. 16(a) shows a state in which the title sorting button 37e is focused and selected by the cursor 35. In this case, the pieces of content are sorted by content title in, for example, alphabetical order. FIG. 16(b) shows a state in which the CH sorting button 37b is selected. In FIG. 16(b), the pieces of content are arranged in the same order as that in FIG. 15(b).

On the content search screen 50 shown in FIG. 16, the cursor 35 is in a display area other than the content list display area 31. For example, when the ring cursor key 12b of the remote controller 12 shown in FIG. 12A is operated to move the cursor 35 to the content list display area 31, the cursor 35 focuses on the first sorting button of the sorting buttons 37a to 37e, namely, the title sorting button 37e, in the content list display area 31. For example, by operating the cross cursor key 12a or the jog dial 12d of the remote controller 12 shown in FIG. 12A or 12B, the cursor 35 is moved to sequentially select the sorting buttons one at a time. After the cursor 35 focuses on the last frequency-of-occurrence sorting button 37c, the cursor 35 focuses on the content in the content list.

FIG. 17 shows another specific example of a method of displaying content selected from the content list on the content search screen 50 shown in FIG. 8 by way of example. Specifically, FIG. 17 shows a thumbnail 92. Portions in FIG. 17 corresponding to those in FIG. 8 are given the same reference numerals, and repeated descriptions thereof are omitted to avoid redundancy. Also, reference numerals of some of the portions in FIG. 17 corresponding to those in FIG. 8 are omitted.

FIG. 17 shows a state in which the content “DDDDD” in the content list displayed in the content list display area 31 is focused and selected by the cursor 35. For the selected content on the content search screens described above, attribute information of the selected content in the content list is focused by the cursor 35. In this specific example, besides the content attribute information including the content title and the like, the thumbnail 92 is additionally displayed in an area enclosed by the cursor 35.

For example, every time a new piece of content is selected by operating the cross cursor key 12a or the jog dial 12d of the remote controller 12 shown in FIG. 12A or 12B, a thumbnail of the selected piece of content is additionally displayed in this manner. Accordingly, the user can recognize the selected content in more detail than is recognized only from the attributes. In this case, a thumbnail is created for each piece of content stored in the storage unit 14 (FIG. 2) or the storage unit 23 (FIG. 3), and the thumbnail is stored in association with the corresponding content.

This type of display technique is also applicable to the content search screens other than that shown in FIG. 8.

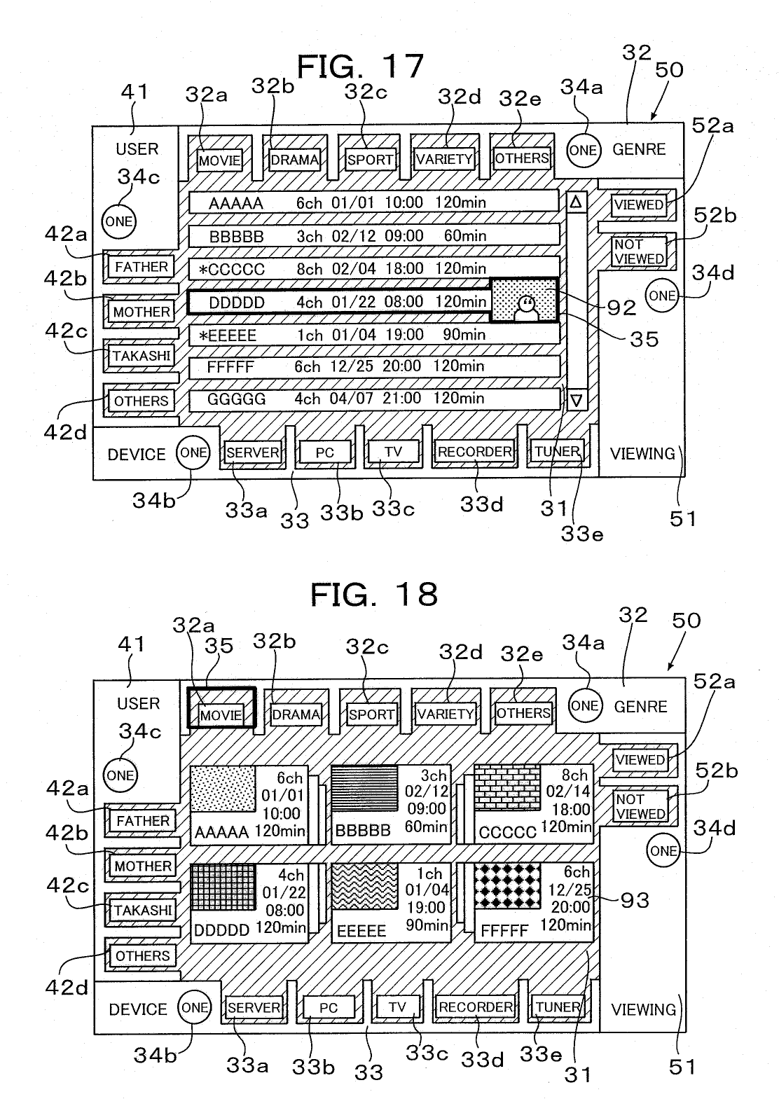

FIG. 18 shows another specific example of a content list displayed in the content list display area 31 on the content search screen 50 shown in FIG. 8 by way of example. Specifically, FIG. 18 shows thumbnails 93. Portions in FIG. 18 corresponding to those in FIG. 8 are given the same reference numerals, and repeated descriptions thereof are omitted to avoid redundancy. Also, reference numerals of some of the portions in FIG. 18 corresponding to those in FIG. 8 are omitted.

Referring to FIG. 18, pieces of content displayed in the content list display area 31 are represented by the thumbnails 93 in this specific example. If the number of thumbnails 93 to be displayed exceeds the number of items that can be displayed at the same time in the content list display area 31, the remaining thumbnails that cannot be displayed at the same time are arranged in a depth direction on the screen, whereby the content list is displayed in three dimensions.

Here, the content search screen 50 has “forward” and “backward” buttons (not shown) indicating the depth direction. By operating the “forward” button, the thumbnails 93 displayed behind the front thumbnail 93 are sequentially moved to the front, thereby sequentially displaying the thumbnails 93 in the rear at the front. The thumbnails 93 are moved in the reverse direction by operating the “backward” button.

Although not shown in FIG. 18, the content list display area 31 has the scrollbar 36, as shown in FIG. 8. By operating the mouse 20 (FIG. 3) of the PC 4 (FIG. 1) or by operating the mouse-pointer operation unit of the remote controller 12 shown in FIGS. 12A and 12B, the scrollbar 36 is scrolled using the mouse pointer (not shown) to scroll the thumbnails 93 in the depth direction on the screen. Accordingly, the second and subsequent thumbnails 93 can be sequentially displayed and viewed at the front.

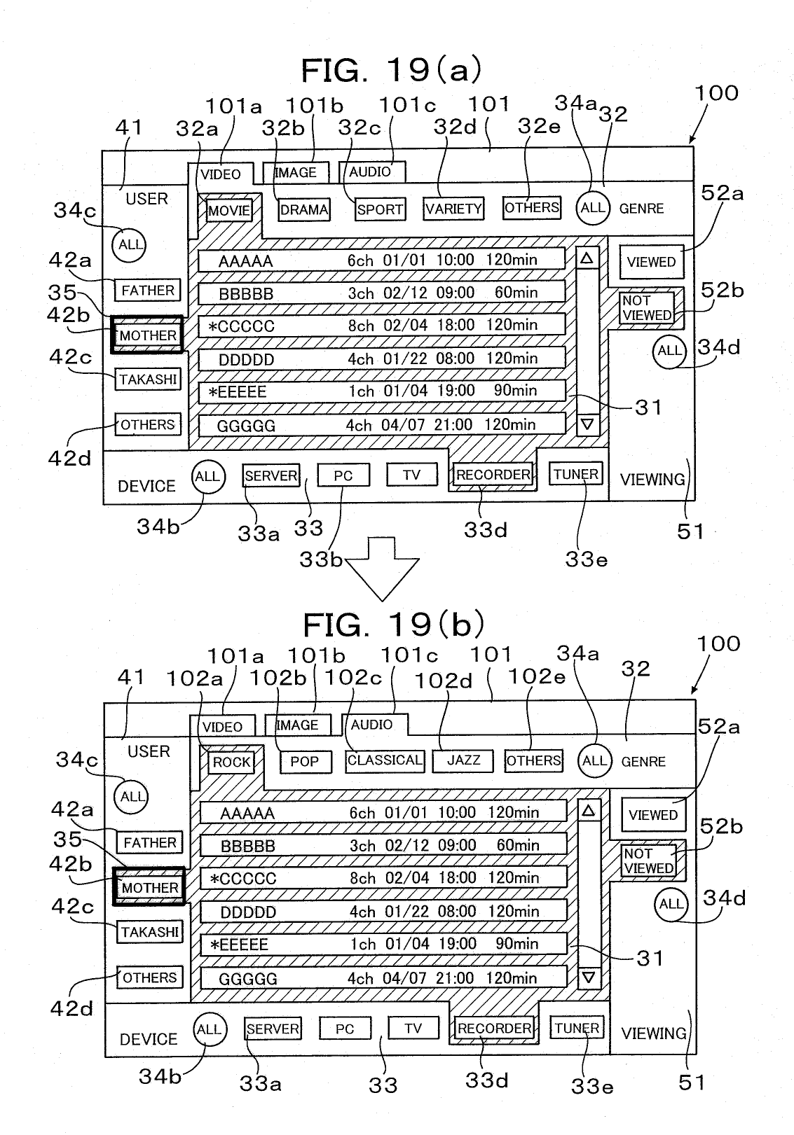

FIG. 19 shows a seventh specific example of a content search screen. Specifically, FIG. 19 shows a content search screen 100, an information type display area 101, information type selection buttons 101a to 101c, and genre selection buttons 102a to 102e. Portions in FIG. 19 corresponding to those in the previous drawings are given the same reference numerals, and repeated descriptions thereof are omitted to avoid redundancy. Also, reference numerals of some of the portions in FIG. 19 corresponding to those in the previous drawings are omitted.

Referring to FIG. 19(a), a system using a content search method of this specific example has additional attributes “video”, “image (still image)”, and “audio” serving as “information type”. Under each of the attributes “video”, “image”, and “audio”, the attribute “genre” is expanded. The attributes with a hierarchical structure are used in the system.

For the attributes with a hierarchical structure, the information type selection button 101a indicating the attribute “video”, the information type selection button 101b indicating the attribute “image”, and the information type selection button 101c indicating the attribute “audio” are arranged in the information type display area 101. The selected information type selection button is displayed on a tab protruding from the genre display area 32. In the genre display area 32, genre selection buttons at a lower hierarchy level corresponding to the selected information type selection button are displayed. FIG. 19(a) shows a state in which the “video” information type selection button 101a is selected. Thus, the genre selection buttons 32a to 32e at a lower hierarchy level are displayed in the genre display area 32.

FIG. 19(b) shows a state in which the “audio” information type selection button 101c is selected in the display state shown in FIG. 19(a). In the genre display area 32, the “rock” genre selection button 102a, the “pop” genre selection button 102b, the “classical” genre selection button 102c, the “jazz” genre selection button 102d, and the “others” genre selection button 102e at a lower hierarchy level are displayed.

As in the previous content search screens, the “video” information type selection button 101a, the “image” information type selection button 101b, and the “audio” information type selection button 101c are selected one at a time by the cursor 35. When one of the “video” information type selection button 101a, the “image” information type selection button 101b, and the “audio” information type selection button 101c is focused by the cursor 35 and is selected and confirmed, the genre selection buttons at a hierarchy level lower than the selected information type selection button are automatically displayed in the genre display area 32. At the same time, the cursor 35 is moved to the genre display area 32, and one of the genre selection buttons is focused and selected.

For example, by operating the ring cursor key 12b of the remote controller 12 shown in FIG. 12A, the cursor 35 can be moved to the information type display area 101. Accordingly, another information type selection button can be selected and confirmed.

The cursor 35 can be moved from the information type display area 101 to another display area or from another display area to the information type display area 101 in a manner similar to the case of the content search screen described above.

Portions other than the aforementioned points are the same as those of the content search screen 50 shown in FIG. 8. Needless to say, the same is applicable to the other content search screens.

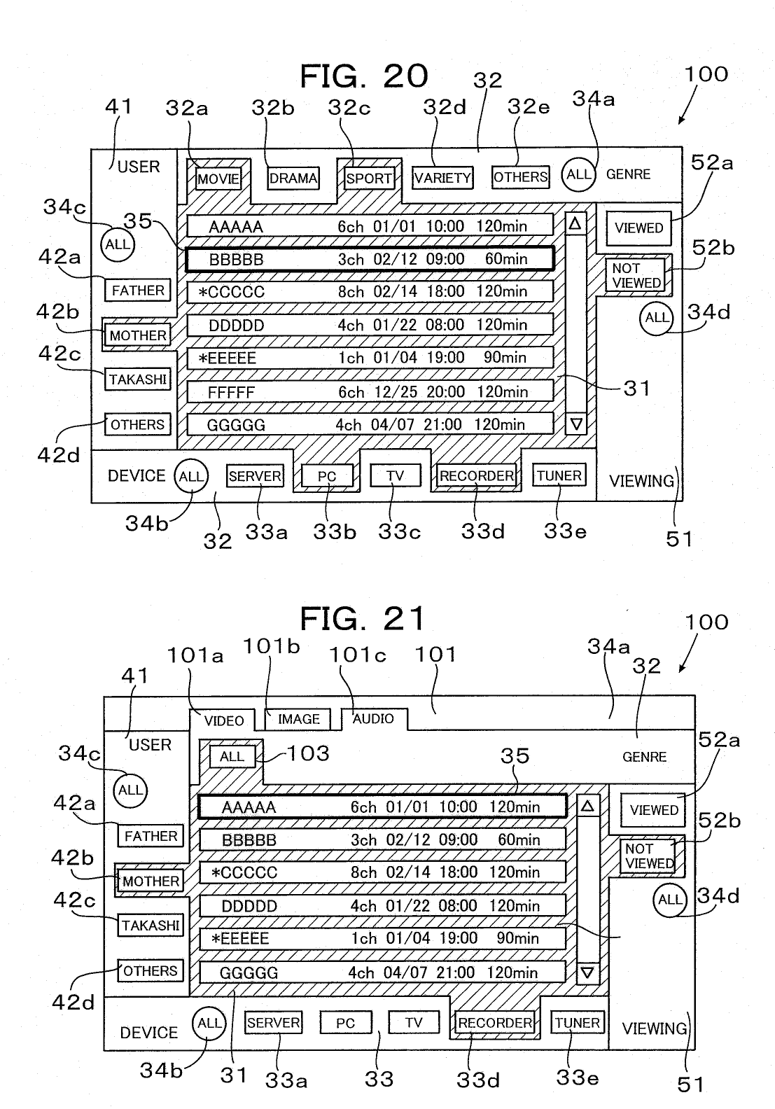

FIG. 20 shows an eighth specific example of a content search screen. Specifically, FIG. 20 shows a content search screen 110. Portions in FIG. 20 corresponding to those in FIG. 8 are given the same reference numerals, and repeated descriptions thereof are omitted to avoid redundancy. Also, reference numerals of some of the portions in FIG. 20 corresponding to those in FIG. 8 are omitted.

Referring to FIG. 20, two or more than two selection buttons can be selected and confirmed at the same time in each display area having three or more than three selection buttons. Here, the “movie” genre selection button 32a and the “sport” genre selection button 32c are selected and confirmed in the genre display area 32, and the “PC” device selection button 33b and the “recorder” device selection button 33d are selected and confirmed in the device display area 33. In this case, pieces of content that are displayed in the content list in the content list display area 31 are those stored in the PC4 and the recorder with the DMP function 3, which are shown in FIG. 1, and the genres of which are “movie” and “sport”.

In this case, the remote controller 12 shown in FIGS. 12A and 12B has a function of selecting and confirming different selection buttons in the same display area. That is, one selection button is selected and confirmed by operating the cross cursor key 12a or the jog dial 12d and by operating the confirm key 12c of the remote controller 12, and thereafter, another selection button is selected and confirmed, without operating the ring cursor key 12b, by operating the cross cursor key 12a or the jog dial 12d and by operating the confirm key 12c.

In the genre display area 32 shown in FIG. 20, after the “movie” genre selection button 32a is selected by operating the cross cursor key 12a or the jog dial 12d and confirmed by operating the confirm key 12c, the cursor 35 is not moved to another display area, and the “sport” genre selection button 32c is selected by operating the cross cursor key 12a or the jog dial 12d and confirmed by operating the confirm key 12c. As a result, both the “movie” genre selection button 32a and the “sport” genre selection button 32c are selected and confirmed. In this manner, two or more than two selection buttons can be simultaneously selected and confirmed in the same display area.

For example, when the cursor 35 is in a display area other than the genre display area 32, the cursor 35 is moved to the genre display area 32 by operating the remote controller 12 shown in FIGS. 12A and 12B or the keyboard 22 (FIG. 3) of the PC 4. When a selection button other than the selection buttons that have been selected and confirmed (the “movie” genre selection button 32a and the “sport” genre selection button 32c in FIG. 20), such as the “drama” genre selection button 32b, is selected and confirmed, the selection and confirmation of the selection buttons that have been selected and confirmed, namely, the “movie” genre selection button 32a and the “sport” genre selection button 32c, is cancelled.

Although the eighth specific example has been described using the configuration of the content search screen 50 shown in FIG. 8 by way of example, the same applies to the other content search screens described above.

FIG. 21 shows a ninth specific example of a content search screen. Specifically, FIG. 21 shows an “all” tab 103. Portions in FIG. 21 corresponding to those in FIG. 19 are given the same reference numerals, and repeated descriptions thereof are omitted to avoid redundancy.

Referring to FIG. 21, a plurality of information type selection buttons displayed in the information type display area 101 can be selected and confirmed at the same time in the ninth specific example. Here, the “video” information type selection button 101a and the “audio” information type selection button 101c are simultaneously selected and confirmed.

To select these buttons, the remote controller 12 is operated in a manner similar to that described with reference to FIG. 20. When the cursor 35 is in the information type display area 101, two or more than two information type selection buttons can be simultaneously selected and confirmed by performing the same operation as that performed when the cursor 35 is in the genre display area 32 in FIG. 20.

When a plurality of information type selection buttons are selected and confirmed in the information type display area 101 in this manner, no genre selection buttons are displayed in the genre display area 32. Instead, the “all” tab 103 protruding from the content list display area 31 is displayed. In this case, pieces of content in the content list displayed in the content list display area 31 are all pieces of content that have all the genre attributes at a hierarchy level lower than the information type attribute “video” and that have all the genre attributes at a hierarchy level lower than the attribute “audio”.

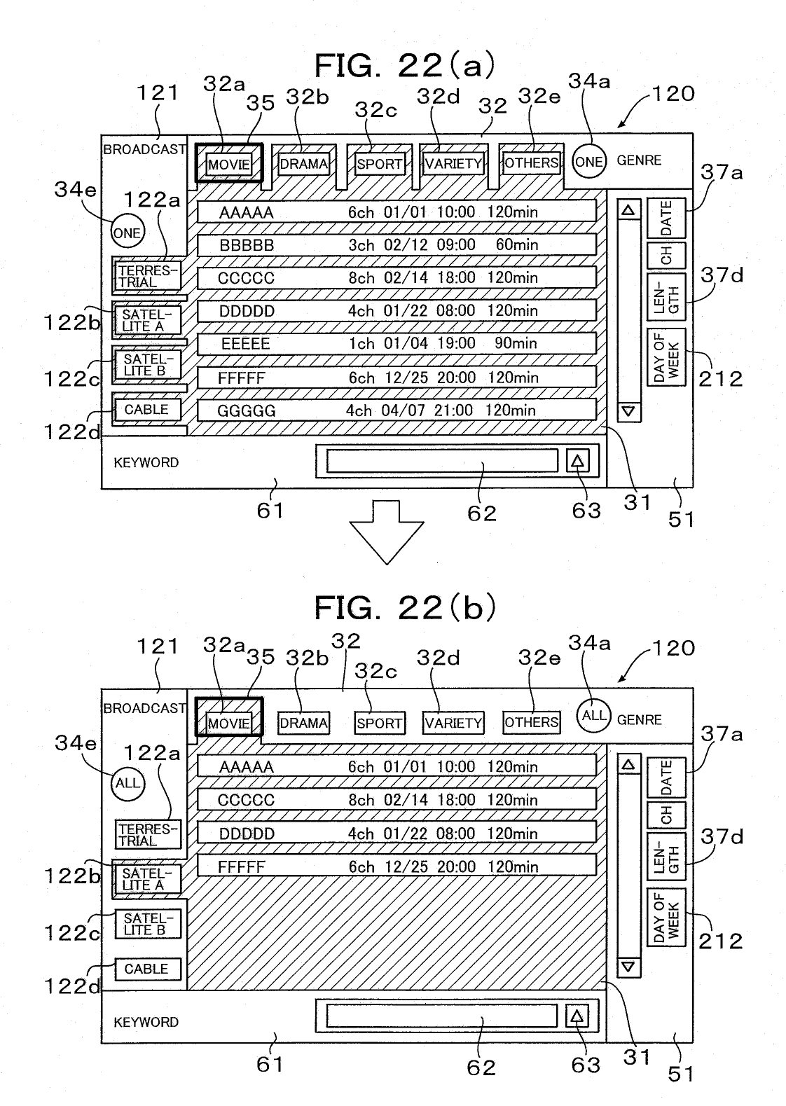

FIG. 22 shows a tenth specific example of a content search screen. Specifically, FIG. 22 shows a content search screen 120, a broadcast display area 121, and broadcast selection buttons 122a to 122d. Portions in FIG. 22 corresponding to those in FIG. 9 are given the same reference numerals, and repeated descriptions thereof are omitted to avoid redundancy.

Referring to FIG. 22, the screen configuration of the content search screen 120 of this specific example is similar to that of the content search screen 60 shown in FIG. 9. The content search screen 120 has the broadcast display area 121, instead of the user display area 41. Accordingly, a search can be conducted through recorded programs.

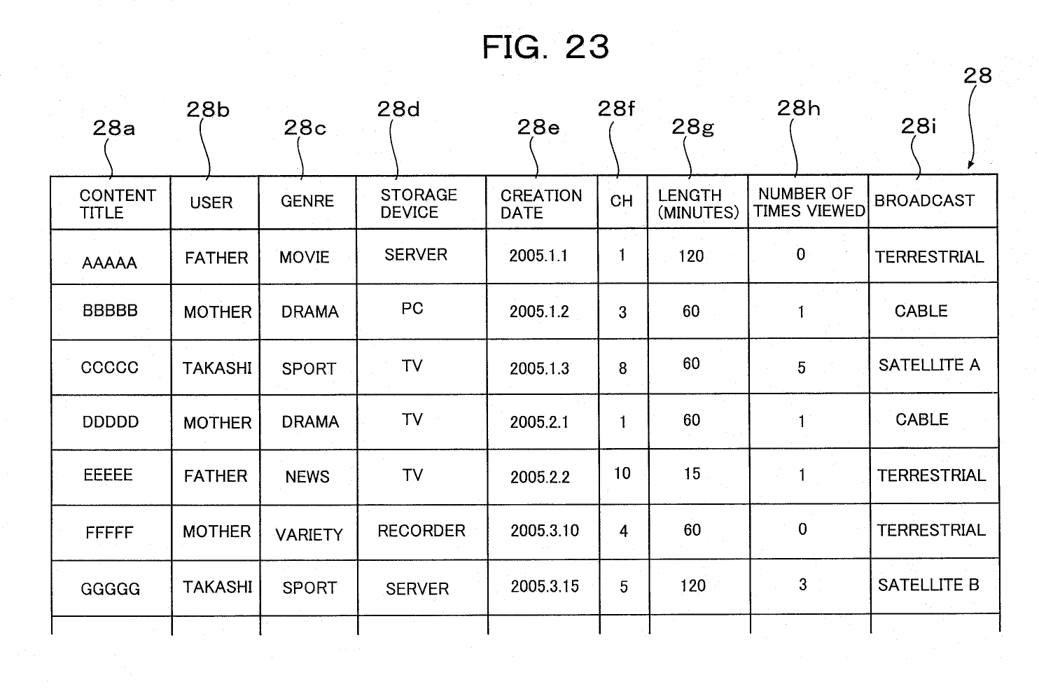

FIG. 23 shows a content list 28 in this case. The content list 28 has, besides the content list shown in FIG. 5, an additional attribute “broadcast” 28i. The attribute “broadcast” 28i indicates a broadcast source serving as a content provider. For example, the attribute “terrestrial” indicates that a program broadcast by a terrestrial broadcasting station is recorded.

Referring to FIG. 22, the broadcast display area 121 has the “terrestrial” broadcast selection button 122a for selecting a recorded program broadcast by a terrestrial broadcasting station, the “satellite A” broadcast selection button 122b for selecting a recorded program broadcast by satellite broadcasting A, the “satellite B” broadcast selection button 122c for selecting a recorded program broadcast by satellite broadcasting B, and the “cable” broadcast selection button 122d for selecting a recorded cable television program. As in the other display areas, the broadcast display area 121 additionally has the one/all selection button 34e. By operating the one/all selection button 34e to select “all”, a content list in which all the broadcast selection buttons 122a to 122d are selected is displayed in the content list display area 31, as shown in FIG. 22(a). By operating the one/all selection button 34e in the state shown in FIG. 22(a) to select “one”, one of the broadcast selection buttons 122a to 122d, e.g., the “satellite A” broadcast selection button 122b, is selected, and a content list of recorded programs that are obtained from satellite broadcasting A is displayed in the content list display area 31, as shown in FIG. 22(b).

By displaying an attribute menu of the attributes 28a to 28i shown in FIG. 23 on the screen, the attributes serving as the search criteria may be selected from the attribute menu. Accordingly, a content search can be conducted using arbitrary search criteria.

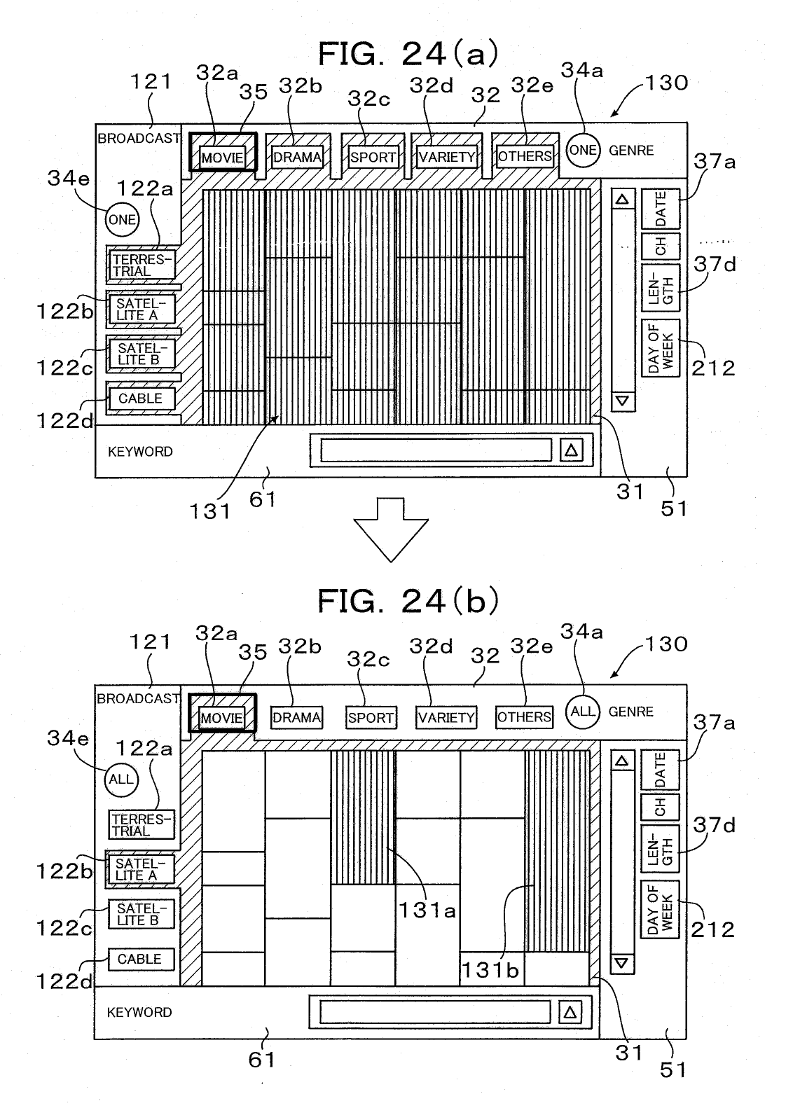

FIG. 24 shows an eleventh specific example of a content search screen. Specifically, FIG. 24 shows a content search screen 130, an electronic program guide (EPG) 131, and recorded programs 132a and 132b. Portions in FIG. 24 corresponding to those in FIG. 22 are given the same reference numerals, and repeated descriptions thereof are omitted to avoid redundancy.

Referring to FIG. 24, the screen configuration of the content search screen 130 of this specific example is similar to that of the content search screen 120 shown in FIG. 22. The content list display area 31 displays the EPG 131 obtained from a broadcasting program signal. In the EPG 131, each segmented frame represents a program broadcast by a broadcasting station. “Hits” or recorded programs that match the search criteria (specified attributes) are displayed distinguishably from those that do not match the search criteria. Here, “hits” or recorded programs that match the search criteria are hatched (a broadcasting station that has no “hits” may be omitted from the EPG 131).

FIG. 24(a) shows a display state in which “all” is selected by the one/all selection button 34a in the genre display area 32 and “all” is selected by the one/all selection button 34e in the broadcast display area 121. In this case, all the genre attributes and all the broadcast attributes serve as search criteria, and all recorded programs match these search criteria. FIG. 24(b) shows a display state in which “one” is selected by both the one/all selection buttons 34a and 34e. In this case, the hits are the recorded programs 131a and 131b matching the attributes “movie” and “satellite A” serving as the search criteria.

The content search screens described above are used to search recorded programs or the like using the search criteria. A content search screen used to search programs scheduled to be recorded can have a similar screen configuration. This point will be described using the content search screen 120 shown in FIG. 22 or the content search screen 130 shown in FIG. 24 by way of example.

By selecting the item “view (or play)” from a menu screen (not shown) including the items “view (or play)” and “record” initially displayed on the display screen, the content search screen 120 shown in FIG. 22 or the content search screen 130 shown in FIG. 24 with the above-described functions is displayed, and “hits” or recorded programs that match the attributes serving as the search criteria are displayed, as has been described above.

In contrast, when the item “record” is selected, a content search screen in a similar format as that shown in FIG. 22 or FIG. 24, namely, the content search screen 120 in a content list format or the content search screen 130 in an EPG format, is displayed, and “hits” or programs that match the selected attributes serving as the search criteria are displayed as pieces of content in the content list display area 31. The user selects a selection button in each display area to narrow the programs. In this case, when all the selection buttons are selected, all the programs are displayed as active, as shown in FIG. 22(a) or FIG. 24(a). When not all of the selection buttons are selected to narrow the search criteria, only the “hits” matching the search criteria are shown, as shown in FIG. 22(b), or programs other than the “hits” are displayed as inactive, as shown in FIG. 24(b).

Needless to say, the above-described content search screen for scheduling a program to be recorded can be displayed in a format of any of the previously-described content search screens other than those shown in FIGS. 22 and 24.

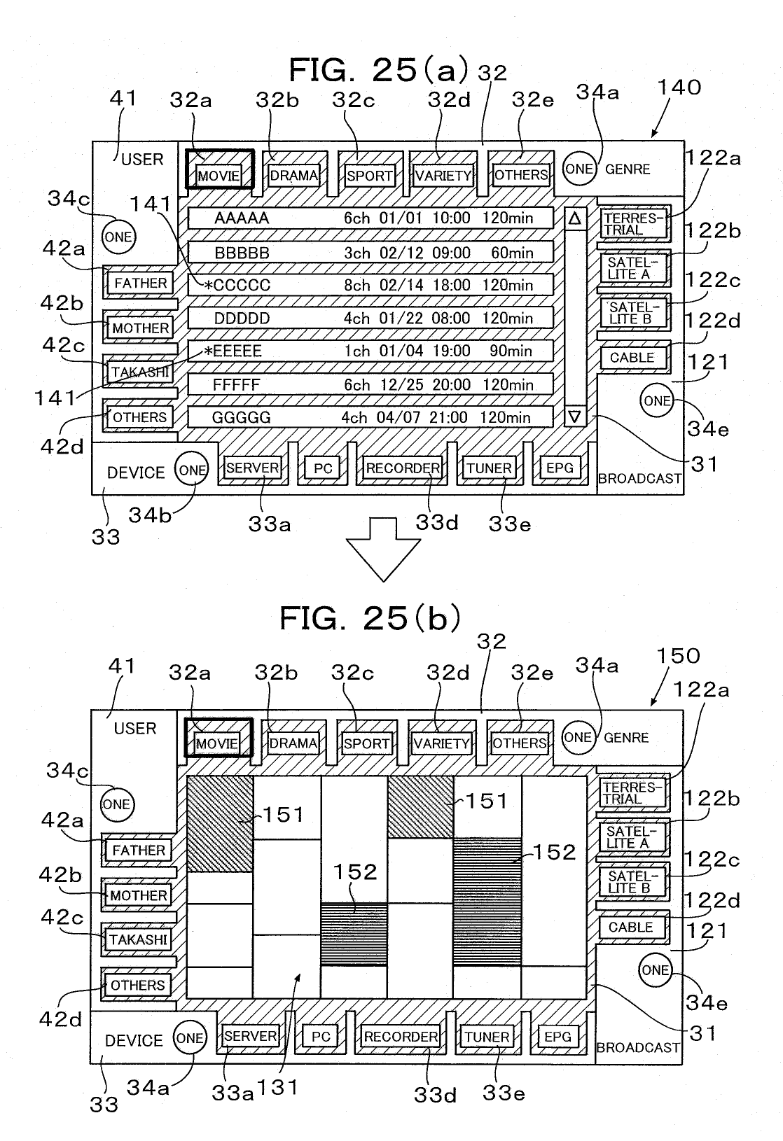

FIGS. 25A and 25B shows specific examples of a content search screen for searching recorded programs, programs scheduled to be recorded, and programs that are neither recorded nor scheduled to be recorded. Specifically, FIG. 25A shows a content search screen 140 and scheduled recording symbols 141, and FIG. 25B shows a content search screen 150, programs scheduled to be recorded 151, and recorded programs 152. Portions in FIGS. 25A and 25B corresponding to those in the previous drawings are given the same reference numerals, and repeated descriptions thereof are omitted to avoid redundancy.

The content search screen 140 shown in FIG. 25A is, for example, a screen in a format similar to that of the content search screen 120 shown in FIG. 22. The content search screen 140 has, instead of the viewing display area 51 and the keyword display area 61, the device display area 33 and the broadcast display area 121.

On the content search screen 140, a content list including recorded programs, programs scheduled to be recorded, and programs that are neither recorded nor scheduled to be recorded is displayed in the content list display area 31. On the left side of the list, the scheduled recording symbol 141, namely, the asterisk (*) symbol, is given to a program scheduled to be recorded, thereby indicating the status of the program. The other program statuses include “recorded”, “viewed”, or the like. Different symbols may be given to indicate different statuses.

The content search screen 150 shown in FIG. 25B is, for example, a screen in a format similar to that of the content search screen 130 shown in FIG. 24. The content search screen 150 has, instead of the viewing display area 51 and the keyword display area 61, the device display area 33 and the broadcast display area 121.

On the content search screen 150, recorded programs and programs scheduled to be recorded are displayed in different formats, such as using different background patterns or different colors, in a program field of the EPG 131 in the content list display area 31 so that the user can distinguish between these two types. As in FIG. 25(a), the other program statuses may be represented using different background patterns or colors.

Accordingly, in the specific examples shown in FIGS. 25A and 25B, a search can be easily conducted simultaneously through programs in various statuses that match the search criteria.

Needless to say, the above-described content search screens for searching programs in various statuses can be displayed in a format of any of the previously-described content search screens other than those shown in FIGS. 22 and 24.

What is claimed is:

1. A content search method for searching saved content through operation of a displayed content search screen, comprising:
arranging a content list display area in which a content list is displayed on the content search screen;
arranging, along at least two sides of the content list display area, search criteria display areas for displaying search criteria selection buttons indicating different search criteria for searching for content; and
setting the search criteria by selecting the search criteria selection buttons and displaying, in the content list display area, the content list based on the set search criteria as a list of a plurality of pieces of attribute information of pieces of content, the pieces of attribute information being arranged horizontally.

2. The content search method according to claim 1, wherein, from among pieces of content that match the set search criteria, a desired piece of content is obtained by selecting the desired piece of content from the content list displayed in the content list display area.

3. The content search method according to claim 1, wherein, in the search criteria display areas, the selected search criteria selection buttons are displayed on tabs protruding from the content list display area, and the unselected search criteria selection buttons are displayed independently and separately from one another.

4. The content search method according to claim 1, wherein each of the search criteria display areas has a one/all selection button, and, by operating the one/all selection button, the search criteria display area is switched between a state in which all the search criteria selection buttons are selected and a state in which one of the search criteria selection buttons is selected.

5. The content search method according to claim 1, wherein each of the search criteria display areas has a state selection button, and, by operating the state selection button, the search criteria display area is switched between a state in which all the search criteria selection buttons are selected and a state in which an arbitrary number of the search criteria selection buttons are selected.

6. The content search method according to claim 1, wherein a plurality of sorting selection buttons are provided, and, by selecting and operating one of the sorting selection buttons, the pieces of content in the content list are sorted according to the selected sorting button.

7. The content search method according to claim 6, wherein a piece of content selected from the content list is displayed with a thumbnail.

8. The content search method according to claim 1, wherein a processing menu is displayed by selecting one of the pieces of content from the content list displayed in the content list display area, and
wherein the processing menu selectively allows the selected piece of content to be played, deleted, moved or copied to a recording medium of another device.

9. The content search method according to claim 1, wherein at least one of the search criteria has a hierarchical structure, and a display area is provided for search criteria of a higher hierarchical level and a display area is provided for search criteria of a lower hierarchical level, the display areas each having the search criteria selection buttons, and
wherein, by selecting an arbitrary one of the search criteria selection buttons in the display area for the search criteria of the higher hierarchical level, the selection buttons are displayed in the display area for the search criteria of the lower hierarchical level corresponding to the search criterion indicated by the selected selection button.

10. The content search method according to claim 9, wherein at least two of the selection buttons are selectable in the display area for the search criteria of the higher hierarchical level, and
wherein, by selecting the at least two selection buttons, the content list displayed in the content list display area includes pieces of content that satisfy at least one of the search criteria indicated by the selected selection buttons.

11. The content search method according to claim 1, wherein the content list displayed in the content list display area is an electronic program guide obtained from a broadcasting program signal, and a recorded program matching the search criteria indicated by the selected search criteria selection buttons is displayed in the electronic program guide.

12. The content search method according to claim 1, wherein the content list displayed in the content list display area includes thumbnails of the pieces of content, which are arranged and displayed in three dimensions.

13. The content search method according to claim 1, wherein the pieces of content in the content list displayed in the content list display area include a recorded program, a program scheduled to be recorded, and a program that is neither recorded nor scheduled to be recorded.
